(19) United States
(12) Patent Application Publication
(10) Pub. No.: US 2026/0074731 A1
(43) Pub. Date: Mar. 12, 2026

(54) RESERVE ENERGY ALLOCATION BASED ON SPATIAL INFORMATION

(71) Applicant: QUALCOMM Incorporated, San Diego, CA (US)

(72) Inventors: Jagadish NADAKUDUTI, San Diego, CA (US); Nandhini SRINIVASAN, San Diego, CA (US); Lin LU, San Diego, CA (US)

(21) Appl. No.: 19/320,958

(22) Filed: Sep. 5, 2025

Related U.S. Application Data
(60) Provisional application No. 63/691,486, filed on Sep. 6, 2024.

(51) Int. Cl. H04B 1/3827; H04W 52/36

(52) U.S. Cl. CPC H04B 1/3838; H04W 52/367

(57) ABSTRACT

Techniques and apparatus for reserve energy allocation among radios of a wireless device based on spatial information of radio frequency (RF) exposure contributions among antennas of the wireless device are described. An example technique includes determining RF exposure contribution information associated with a plurality of antennas for radio(s) of the wireless device. The RF exposure contribution information includes, for each antenna, a respective indication of RF exposure contribution from the antenna on RF exposure contributor(s). A reserve level for each of the radio(s) is determined, based at least in part on the RF exposure contribution information. First signal(s) are transmitted using at least one of the radio(s) at a first transmit power determined based at least in part on an RF exposure limit associated with each of the radio(s) and the reserve level for each of the radio(s).

### CROSS-REFERENCE TO RELATED APPLICATION

This application claims priority to U.S. Patent Application No. 63/691,486, filed Sep. 6, 2024, which is hereby incorporated by reference herein in its entirety for all applicable purposes.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance.

Certain aspects of the subject matter described in this disclosure can be implemented in a method for wireless communication. The method generally includes determining radio frequency (RF) exposure contribution information associated with a plurality of antennas for one or more radios of the wireless device. The RF exposure contribution information includes, for each antenna, a respective indication of RF exposure contribution from the antenna on one or more RF exposure contributors. The method also includes determining a reserve level for each of the one or more radios, based at least in part on the RF exposure contribution information. The method further includes transmitting one or more first signals using at least one of the one or more radios at a first transmit power determined based at least in part on an RF exposure limit associated with each of the one or more radios and the reserve level for each of the one or more radios.

Certain aspects of the subject matter described in this disclosure can be implemented in an apparatus for wireless communication. The apparatus includes one or more memories collectively storing executable instructions, and one or more processors coupled to the one or more memories. The one or more processors are collectively configured to execute the executable instructions to cause the apparatus to perform an operation. The operation includes determining radio frequency (RF) exposure contribution information associated with a plurality of antennas for one or more radios of the apparatus. The RF exposure contribution information includes, for each antenna, a respective indication of RF exposure contribution from the antenna on one or more RF exposure contributors. The operation also includes determining a reserve level for each of the one or more radios, based at least in part on the RF exposure contribution information. The operation also includes transmitting one or more first signals using at least one of the one or more radios at a first transmit power determined based at least in part on an RF exposure limit associated with each of the one or more radios and the reserve level for each of the one or more radios.

Certain aspects of the subject matter described in this disclosure can be implemented in an apparatus for wireless communication. The apparatus generally includes means for determining radio frequency (RF) exposure contribution information associated with a plurality of antennas for one or more radios of the apparatus. The RF exposure contribution information includes, for each antenna, a respective indication of RF exposure contribution from the antenna on one or more RF exposure contributors. The apparatus also includes means for determining a reserve level for each of the one or more radios, based at least in part on the RF exposure contribution information. The apparatus further includes means for transmitting one or more first signals using at least one of the one or more radios at a first transmit power determined based at least in part on an RF exposure limit associated with each of the one or more radios and the reserve level for each of the one or more radios.

Certain aspects of the subject matter described in this disclosure can be implemented in a computer-readable medium. The computer-readable medium has instructions stored thereon for performing an operation. The operation includes determining radio frequency (RF) exposure contribution information associated with a plurality of antennas for one or more radios of a wireless device. The RF exposure contribution information includes, for each antenna, a respective indication of RF exposure contribution from the antenna on one or more RF exposure contributors. The operation also includes determining a reserve level for each of the one or more radios, based at least in part on the RF exposure contribution information. The operation also includes transmitting one or more first signals using at least one of the one or more radios at a first transmit power determined based at least in part on an RF exposure limit associated with each of the one or more radios and the reserve level for each of the one or more radios.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with an RF exposure limit, in accordance with certain aspects of the present disclosure.

FIG. 4 illustrates an example data structure including RF exposure contribution information for antennas of a wireless device, in accordance with certain aspects of the present disclosure.

FIG. 5 illustrates an example workflow for a time-averaged RF exposure compliance evaluation based on RF exposure contribution information, in accordance with certain aspects of the present disclosure.

FIG. 6A is a graph illustrating examples of transmit powers over time according to a time-averaged mode, in accordance with certain aspects of the present disclosure.

FIG. 6B is a graph illustrating examples of transmit powers over time according to a peak mode, in accordance with certain aspects of the present disclosure.

FIG. 7A is a graph illustrating examples of reserve operation for a time-averaged mode, in accordance with certain aspects of the present disclosure.

FIG. 7B is a graph illustrating examples of reserve operation for a peak mode, in accordance with certain aspects of the present disclosure.

FIG. 8 depicts graphs illustrating different example exposure budgets for a transmission scenario, in accordance with certain aspects of the present disclosure.

FIG. 9 is a flow diagram illustrating example operations for allocating excess reserve margin among radios, in accordance with certain aspects of the present disclosure.

FIG. 10 is a flow diagram illustrating example operations for wireless communication by a wireless device, in accordance with certain aspects of the present disclosure.

FIG. 11 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for reserve energy allocation among radios of a wireless device based on spatial information of RF exposure contributions among antennas of the wireless device.

In certain cases, a wireless device may evaluate RF exposure compliance using a two-dimensional (2D) RF exposure distribution (e.g., a specific absorption rate (SAR) distribution and/or power density (PD) distribution). The wireless device may perform a time-averaged RF exposure assessment over a given time window to determine a maximum allowable transmit power using the RF exposure distribution. In some cases, however, the RF exposure distribution may represent the maximum RF exposure exhibited by one or more antennas of the wireless device without regard to the spatial distribution of the RF exposure among the antennas.

In some RF exposure distributions, for example, all of the RF exposure hotspots (or peak RF exposures) from the antennas of the wireless device may be collocated. In such RF exposure distributions, each of the maximum RF exposures may correspond to the peak RF exposure across all of the surfaces of the wireless device, such that there is no distinction with respect to where the RF exposure is being emitted from the wireless device.

In other RF exposure distributions, all of the RF exposure hotspots (or peak RF exposures) from the antennas within an antenna group may be collocated. In such RF exposure distributions, each of the maximum RF exposures within an antenna group may correspond to the peak RF exposure across all antennas within the antenna group, such that there is no distinction with respect to where the RF exposure is being emitted from antennas within the antenna group. For example, the peak locations of RF exposure may not be at the same location for all antennas of an antenna group.

Additionally, certain wireless devices may be configured to reserve some of the time-averaged RF exposure energy (referred to herein as a “reserve” or “reserve margin” or “reserve level”) in a time-averaging window. For example, certain wireless devices may be configured with a reserve (e.g., minimum reserve) associated with radios of the wireless device and may split (or allocate) the reserve among the radios when multiple radios are actively transmitting at the same time. In some cases, such a reserve may be preserved to enable continuous transmission within a time window while transmitting above a transmit power limit, to enable a certain level of quality for certain transmissions, and/or maintain an RF link associated with the wireless device, as illustrative examples.

However, in certain time-averaging RF exposure compliances that assume that all (or at least some of) the peak RF exposures of antenna(s) of the wireless device are collocated, allocating a reserve among radios of a wireless device can lead to an unnecessarily low reserve allocation for one or more radios, impacting the performance of the wireless device in terms of reduced throughput, increased latency, reduced RF link quality, and decreased range, as illustrative examples.

Certain aspects of the present disclosure provide apparatus and methods for allocating reserve energy among radios of a wireless device based on RF exposure contribution information associated with antennas for the radios of the wireless device. The RF exposure contribution information may include, for each antenna, an indication of spatial contribution of RF exposure from the antenna on one or more RF exposure contributors. In some cases, the RF exposure contributor(s) may include each other antenna of the wireless device. In other cases, the RF exposure contributor(s) may include one or more composite RF exposure maps for one or more antennas of the wireless device. In other cases, the RF exposure contributor(s) may include one or more regions of an RF exposure distribution (or map) for the wireless device. In yet other cases, the RF exposure contributor(s) may include one or more surfaces of the wireless device.

In certain aspects, the indications of spatial RF exposure contributions for each antenna may be represented with an RF exposure contribution matrix, which includes a respective contribution factor (or contribution ratio) corresponding to a level of interaction of RF exposure from the antenna on one of the RF exposure contributor(s).

In certain aspects, a reserve level for each of the radios of the wireless device is determined based at least in part on the RF exposure contribution information. Signals may be transmitted using one or more of the radios at a transmit power determined based at least in part on an RF exposure limit associated with each of the radios and the reserve level for each of the radios.

The apparatus and methods for allocating reserve energy among radios based on RF exposure contribution information associated with antennas of a wireless device may facilitate improved wireless communication performance in terms of improved signal quality at the receiver, higher throughput, decreased latency, and increased range, as illustrative examples. For example, as opposed to allocating reserved energy under an assumption that all (or at least some of) the peak RF exposures of antennas are collocated, the reserve energy allocation described herein based on RF exposure contribution information may provide a more accurate assessment of the RF exposure occurring at locations across the wireless device, allowing the wireless device to determine a higher reserve allocation for the radios.

While aspects described herein refer to 2D distributions, it will be understood that the described operations and configurations may also be applied to three-dimensional (3D) maps or distributions.

The following description provides examples of RF exposure compliance, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced, using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transmitters (or transceivers), and/or RATs (e.g., radio frequency identification (RFID), wireless wide area network (WWAN), wireless local area network (WLAN), short-range communications (e.g., Bluetooth), non-terrestrial communications, device-to-device (D2D) communications, vehicle-to-everything (V2X) communications, etc.) used for wireless communications. For example, for uplink carrier aggregation (or multi-connectivity) in WWAN, each of the active component carriers used for wireless communications may be treated as a separate radio. Similarly, multi-band transmissions for Institute of Electrical and Electronics Engineers (IEEE) 802.11 may be treated as separate radios for each frequency band (e.g., 2.4 gigahertz (GHz), 5 GHz, and/or 6 GHZ). In some examples, a radio is defined based on a RAT and/or frequency for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G New Radio (NR)) wireless technologies, aspects of the present disclosure can be applied in other generation-based communication systems and/or to wireless technologies such as IEEE 802.11, 802.15, etc.

Although the terms “first,” “second,” “third,” etc., may be used herein to describe various devices, elements, components, regions, layers and/or sections, these devices, elements, components, regions, layers, and/or sections should not be limited by these terms. These terms may be only used to distinguish one device, element, component, region, layer or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

### Example Wireless Communication Network and Devices

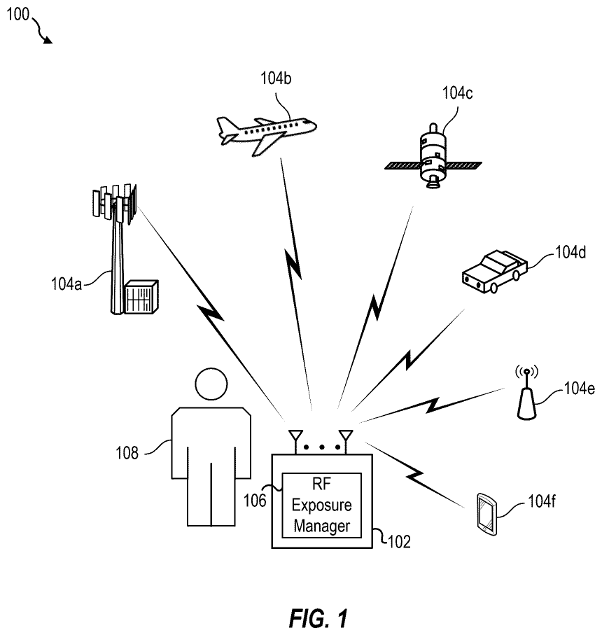

FIG. 1 illustrates an example wireless communication system 100 in which aspects of the present disclosure may be performed. For example, the wireless communication system 100 may include an RFID system, a WWAN, and/or a WLAN. For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a D2D communications network or a short-range communications system, such as Bluetooth communications.

As illustrated in FIG. 1, the wireless communication system 100 may include a wireless device 102 communicating with any of various wireless devices 104a-104f (a wireless device 104) via any of various RATs, where a wireless device may refer to a wireless communication device. The RATs may include, for example, RFID communications, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may be positioned proximate to the human 108 as a mobile hotspot. To ensure the human 108 is not overexposed to RF emissions from the wireless device 102, the wireless device 102 may control the transmit power associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station, an access point, a customer-premises equipment (CPE), etc. In certain aspects, the wireless device 102 includes an RF exposure manager 106 that manages the RF exposure associated with one or more radios in compliance with an RF exposure limit. The RF exposure manager 106 may allocate reserve energy among radios using RF exposure contribution information described herein while maintaining time-averaged RF exposure compliance, in accordance with certain aspects of the present disclosure.

The wireless devices 104a-104f may include, for example, a base station 104a, an aircraft 104b, a satellite 104c, a vehicle 104d, an access point 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point (AP), base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mm Wave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as RFID, 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., RFID, 3G, 4G, 5G, 802.11a/b/g/n/ac, etc.) and a second wireless communication technology operating above 6 GHZ (e.g., mmWave 5G in 24 to 60 GHz bands, IEEE 802.11ad or 802.11ay). In certain aspects, the wireless device may transmit signals using the first wireless communication technology (e.g., RFID, 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may additionally include bands in the 6,000 MHz and/or 7,000 MHz range in other examples.

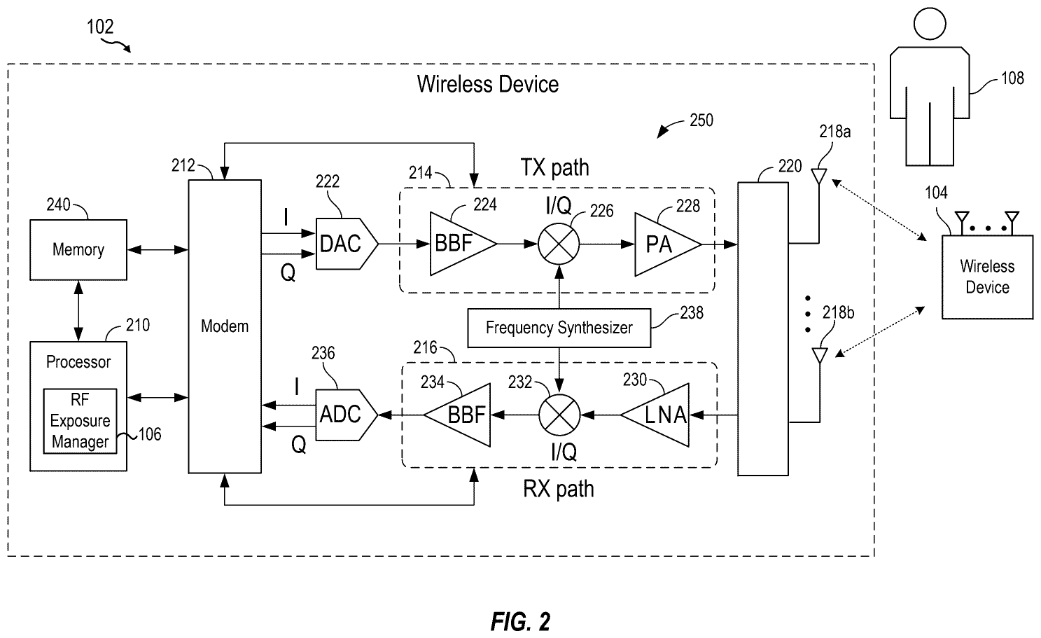

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package, or device that includes one or more modems 212. In some cases, the modem(s) 212 may include, for example, any of an RFID modem (e.g., a modem configured to communicate via RFID), a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

The processor 210 may implement the RF exposure manager 106. In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem, the RFID modem, and/or Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via a first antenna 218a, and a second signal may be transmitted via a second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for in-phase and quadrature (I/Q) imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program code (e.g., computer-readable instructions) for performing wireless communications as described herein. The memory 240 may be external to the processor 210 and/or the modem 212 (as illustrated) and/or incorporated therein.

In certain cases, the RF exposure manager 106 (as implemented via the processor 210 and/or modem 212) may allocate reserve energy among radios using RF exposure contribution information described herein while maintaining time-averaged RF exposure compliance, in accordance with certain aspects of the present disclosure.

FIG. 2 shows one reference example of a transceiver design. It will be appreciated that other transceiver designs or architectures may be applied in connection with certain aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example RF Exposures

As noted, RF exposure may be expressed in terms of SAR and/or PD. As also noted, a wireless device (e.g., the wireless device 102) may be capable of transmitting signals using multiple wireless communication technologies. For example, the wireless device may transmit signals using a first wireless communication technology (e.g., 3G, 4G, 5G in sub-6 GHz bands, IEEE 802.11ac, etc.) in which RF exposure may be measured in terms of SAR, and a second wireless communication technology (e.g., 5G in 24 to 71 GHz bands, IEEE 802.11ad, 802.11ay, etc.) in which RF exposure may be measured in terms of PD.

To assess RF exposure from transmissions using the first technology (e.g., 3G, 4G, 5G in sub-6 GHz bands, IEEE 802.11ac, etc.), the wireless device may include multiple SAR values and/or distributions for the first technology stored in memory (e.g., memory 240 of FIG. 2). Each of the SAR values and/or distributions may correspond to a respective one of multiple transmit scenarios supported by the wireless device for the first technology. The transmit scenarios may correspond to various combinations of radios (e.g., radio(s) 250 of FIG. 2), communication technologies (e.g., RAT(s)), antennas (e.g., antenna(s) 218 of FIG. 2), antenna groupings (or antenna groups), antenna configurations, single-input, single-output (SISO) or multiple-input, multiple-output (MIMO) transmissions, operating conditions (or modes), frequency bands, RF exposure scenarios (e.g., head exposure, body-worn exposure, extremity (hand) exposure, and/or hotspot exposure), device use-case scenarios (e.g., based on active applications on the device such as voice vs. data applications, gaming vs. video-call applications active on the device), physical configurations of a device (e.g., folded, closed, unfolded, open), and/or geographical locations or regions (e.g., countries or regions), as discussed further below. In some examples, the stored SAR value and/or distribution includes a single value (e.g., a peak value determined based on the description below, or a sum of peak values).

The SAR values and/or distribution (also referred to as a SAR map) for each transmit scenario may be generated based on measurements (e.g., E-field measurements) performed in a test laboratory using a model of a human body. After generation, the SAR values and/or distributions are stored in the memory to enable a processor (e.g., processor 210 of FIG. 2) to assess RF exposure in real time, as discussed further below. Each SAR distribution may include a set of SAR values, where each SAR value may correspond to a different location (e.g., on the model of the human body). Each SAR value may comprise a SAR value averaged over a mass of 1 g or 10 g at the respective location.

The SAR values in each SAR distribution correspond to a particular transmission power level (e.g., the transmission power level at which the SAR values were measured in the test laboratory). Since SAR scales with transmission power level, the processor may scale a SAR value or distribution for any transmission power level by multiplying each SAR value (e.g., in the SAR distribution) by the following transmission power scaler:

$$\frac{T {x}_{c}}{{Tx}_{SAR}} \qquad ( 1 )$$

where Tx_{c} is a current transmission power level for the respective transmit scenario, and TX_{SAR} is the transmission power level corresponding to the SAR values (e.g., the transmission power level at which the SAR values were measured in the test laboratory).

As discussed above, the wireless communication device may support multiple transmit scenarios for the first technology. In certain aspects, the transmit scenarios may be specified by a set of parameters. The set of parameters may include, without limitation, one or more of the following: a radio parameter indicating one or more radios used for transmission (e.g., active radios), an antenna parameter indicating one or more antennas used for transmission (e.g., active antennas), a parameter indicating SISO transmission or MIMO transmission, a parameter indicating a set of operating conditions, a frequency band parameter indicating one or more frequency bands used for transmission (e.g., active frequency bands), a channel parameter indicating one or more channels used for transmission (e.g., active channels), a body position parameter (e.g., a device state index (DSI)) indicating the location of the wireless communication device relative to the user's body location (head, trunk, away from the body, etc.), exposure category, a parameter indicating at least one physical configuration of the wireless communication device, a parameter indicating a geographical location or region (e.g., public land mobile network (PLMN) code and/or a mobile country code (MCC)), and/or other parameters. In cases where the wireless device supports a large number of transmit scenarios, it may be very time-consuming and expensive to perform measurements for each transmit scenario in a test setting (e.g., test laboratory). To reduce test time, measurements may be performed for a subset of the transmit scenarios to generate SAR values and/or distributions for the subset of transmit scenarios. In this example, the SAR values and/or distributions for each of the remaining transmit scenarios may be generated by combining two or more of the SAR values and/or distributions for the subset of transmit scenarios, as discussed further below.

For example, SAR measurements may be performed for each one of the antennas to generate a SAR value or distribution for each one of the antennas. In this example, a SAR value or distribution for a transmit scenario in which two or more of the antennas are active may be generated by combining the SAR values or distributions for the two or more active antennas.

In another example, SAR measurements may be performed for each one of multiple frequency bands to generate a SAR value or distribution for each one of the multiple frequency bands. In this example, a SAR value or distribution for a transmit scenario in which two or more frequency bands are active may be generated by combining the SAR values or distributions for the two or more active frequency bands.

In certain aspects, a SAR distribution may be normalized with respect to a SAR limit by dividing each SAR value in the SAR distribution by the SAR limit. In this case, a normalized SAR value exceeds the SAR limit when the normalized SAR value is greater than one, and is below the SAR limit when the normalized SAR value is less than one. In these aspects, each of the SAR distributions stored in the memory may be normalized with respect to a SAR limit. Similarly, a single or individual SAR value may be normalized with respect to a SAR limit.

In certain aspects, the normalized SAR value or distribution for a transmit scenario may be generated by combining two or more normalized values or SAR distributions. For example, a normalized SAR value or distribution for a transmit scenario in which two or more antennas are active may be generated by combining the normalized SAR values or distributions for the two or more active antennas. For the case in which different transmission power levels are used for the active antennas, the normalized SAR value or distribution for each active antenna may be scaled by the respective transmission power level before combining the normalized SAR values or distributions for the active antennas. The normalized SAR value or distribution for simultaneous transmission from multiple active antennas may be given by the following:

$$S A {R}_{n o r {m}_{-} c o m b i n e d} = {\sum }_{i = 1}^{i = K} \frac{T {x}_{i}}{T {x}_{S A R i}} \cdot \frac{S A {R}_{i}}{S A {R}_{lim}} \qquad ( 2 )$$

where SARₗᵢₘ is a SAR limit, SAR_{norm_combined} is the combined normalized SAR value or distribution for simultaneous transmission from the active antennas, i is an index for the active antennas, SARᵢ is the SAR value or distribution for the i^{th} active antenna, Tx; is the transmission power level for the i^{th} active antenna, TX_{SARi} is the transmission power level for the SAR distribution for the i^{th} active antenna, and K is the number of the active antennas.

Equation (2) may be rewritten as follows:

$$S A {R}_{n o r {m}_{-} c o m b i n e d} = {\sum }_{i = 1}^{i = K} \frac{{Tx}_{i}}{T {x}_{S A R i}} \cdot {SAR}_{norm \_ i} \qquad ( 3 a )$$

where SAR_{norm_i} is the normalized SAR value or distribution for the i^{th} active antenna. In the case of simultaneous transmissions using multiple active antennas at the same transmitting frequency (e.g., MIMO), the combined normalized SAR value or distribution may be obtained by summing the square root of the individual normalized SAR values or distributions and computing the square of the sum, as given by the following:

$$S A {R}_{n o r {m}_{-} combined \_ MIMO} = {[ {\sum }_{i = 1}^{i = K} \sqrt{\frac{T {x}_{i}}{T {x}_{S A R i}} \cdot {SAR}_{n o r {m}_{-} i}} ]}^{2} . \qquad ( 3 b )$$

In another example, normalized SAR values or distributions for different frequency bands may be stored in the memory. In this example, a normalized SAR distribution for a transmit scenario in which two or more frequency bands are active may be generated by combining the normalized SAR distributions for the two or more active frequency bands. For the case where the transmission power levels are different for the active frequency bands, the normalized SAR value or distribution for each of the active frequency bands may be scaled by the respective transmission power level before combining the normalized SAR values or distributions for the active frequency bands. In this example, the combined SAR value or distribution may also be computed using Equation (3a) in which i is an index for the active frequency bands, SAR_{norm_i} is the normalized SAR value or distribution for the i^{th} active frequency band, Txᵢ is the transmission power level for the i^{th} active frequency band, and Tx_{SARi} is the transmission power level for the normalized SAR value or distribution for the i^{th} active frequency band.

To assess RF exposure from transmissions using the second technology (e.g., 5G in 24 to 60 GHz bands, IEEE 802.11ad, 802.11ay, etc.), the wireless device may include multiple PD values and/or distributions for the second technology stored in the memory (e.g., memory 240 of FIG. 2). Each of the PD values or distributions may correspond to a respective one of multiple transmit scenarios supported by the wireless device for the second technology. The transmit scenarios may correspond to various combinations of radios (e.g., radio(s) 250 of FIG. 2), communication technologies (e.g., RAT(s)), antennas (e.g., antenna(s) 218 of FIG. 2), antenna groupings, antenna configurations, operating conditions (or modes), frequency bands, RF exposure scenarios (e.g., head exposure, body-worn exposure, extremity (hand) exposure, and/or hotspot exposure), and/or geographical locations or regions (e.g., countries or regions), as discussed further below. In some examples, the stored PD includes a single value (e.g., a peak value determined based on the description below, or a sum of peak values).

The PD values and/or distribution (also referred to as a PD map) for each transmit scenario may be generated based on measurements (e.g., E-field measurements) performed in a test laboratory using a model of a human body. After generation, the PD values and/or distributions are stored in the memory to enable the processor (e.g., processor 210 of FIG. 2) to assess RF exposure in real time, as discussed further below. Each PD distribution may include a set of PD values, where each PD value may correspond to a different location (e.g., on the model of the human body).

The PD values in each PD distribution correspond to a particular transmission power level (e.g., the transmission power level at which the PD values were measured in the test laboratory). Since PD scales with transmission power level, the processor may scale a PD value or distribution for any transmission power level by multiplying each PD value (e.g., in the PD distribution) by the following transmission power scaler:

$$\frac{T {x}_{c}}{{Tx}_{PD}} \qquad ( 4 )$$

where Tx_{c} is a current transmission power level for the respective transmit scenario, and Tx_{PD} is the transmission power level corresponding to the PD values (e.g., the transmission power level at which the PD values were measured in the test laboratory).

As discussed above, the wireless communication device may support multiple transmit scenarios for the second technology. In certain aspects, the transmit scenarios may be specified by a set of parameters. The set of parameters may include, without limitation, one or more of the following: a radio parameter indicating one or more radios used for transmission (e.g., active radios), an antenna parameter indicating one or more antennas used for transmission (e.g., active antennas), a frequency band parameter indicating one or more frequency bands used for transmission (e.g., active frequency bands), a channel parameter indicating one or more channels used for transmission (e.g., active channels), a body position parameter (e.g., a DSI) indicating the location of the wireless communication device relative to the user's body location (head, trunk, away from the body, etc.), exposure category, a parameter indicating a geographical location or region (e.g., PLMN code and/or a MCC), and/or other parameters. In cases where the wireless device supports a large number of transmit scenarios, it may be very time-consuming and expensive to perform measurements for each transmit scenario in a test setting (e.g., test laboratory). To reduce test time, measurements may be performed for a subset of the transmit scenarios to generate PD values and/or distributions for the subset of transmit scenarios. In this example, the PD values and/or distributions for each of the remaining transmit scenarios may be generated by combining two or more of the PD values and/or distributions for the subset of transmit scenarios, as discussed further below.

For example, PD measurements may be performed for each one of the antennas to generate a PD value or distribution for each one of the antennas. In this example, a PD value or distribution for a transmit scenario in which two or more of the antennas are active may be generated by combining the PD values or distributions for the two or more active antennas.

In another example, PD measurements may be performed for each one of multiple frequency bands to generate a PD value or distribution for each one of the multiple frequency bands. In this example, a PD value or distribution for a transmit scenario in which two or more frequency bands are active may be generated by combining the PD values or distributions for the two or more active frequency bands.

In certain aspects, a PD distribution may be normalized with respect to a PD limit by dividing each PD value in the PD distribution by the PD limit. In this case, a normalized PD value exceeds the PD limit when the normalized PD value is greater than one, and is below the PD limit when the normalized PD value is less than one. In these aspects, each of the PD distributions stored in the memory may be normalized with respect to a PD limit. Similarly, a single or individual PD value may be normalized with respect to a PD limit.

In certain aspects, the normalized PD value or distribution for a transmit scenario may be generated by combining two or more normalized PD values or distributions. For example, a normalized PD value or distribution for a transmit scenario in which two or more antennas are active may be generated by combining the normalized PD values or distributions for the two or more active antennas. For the case in which different transmission power levels are used for the active antennas, the normalized PD value or distribution for each active antenna may be scaled by the respective transmission power level before combining the normalized PD values or distributions for the active antennas. The normalized PD value or distribution for simultaneous transmission from multiple active antennas may be given by the following:

$$P {D}_{n o r {m}_{-} c o m b i n e d} = {\sum }_{i = 1}^{i = L} \frac{T {x}_{i}}{T {x}_{PDi}} \cdot \frac{P {D}_{i}}{P {D}_{lim}} \qquad ( 5 )$$

where PDₗᵢₘ is a PD limit, PDₙₒᵣₘ combined is the combined normalized PD value or distribution for simultaneous transmission from the active antennas, i is an index for the active antennas, PDᵢ is the PD value or distribution for the i^{th} active antenna, Txᵢ is the transmission power level for the i^{th} active antenna, Tx_{PDi} is the transmission power level for the PD distribution for the i^{th} active antenna, and L is the number of the active antennas.

Equation (5) may be rewritten as follows:

$${PD}_{norm \_ combined} = {\sum }_{i = 1}^{i = L} \frac{{Tx}_{i}}{{Tx}_{PDi}} \cdot {PD}_{norm \_ i} \qquad ( 6 a )$$

where PDₙₒᵣₘ_i is the normalized PD value or distribution for the i^{th} active antenna. In the case of simultaneous transmissions using multiple active antennas at the same transmitting frequency (e.g., MIMO), the combined normalized PD value or distribution may be obtained by summing the square root of the individual normalized PD values or distributions and computing the square of the sum, as given by the following:

$${PD}_{norm \_ combined \_ MIMO} = {[ {\sum }_{i = 1}^{i = L} \sqrt{\frac{{Tx}_{i}}{{Tx}_{PDi}} \cdot {PD}_{norm \_ i}} ]}^{2} . \qquad ( 6 b )$$

In another example, normalized PD values or distributions for different frequency bands may be stored in the memory. In this example, a normalized PD value or distribution for a transmit scenario in which two or more frequency bands are active may be generated by combining the normalized PD distributions for the two or more active frequency bands. For the case where the transmission power levels are different for the active frequency bands, the normalized PD value or distribution for each of the active frequency bands may be scaled by the respective transmission power level before combining the normalized PD values or distributions for the active frequency bands. In this example, the combined PD value or distribution may also be computed using Equation (6a) in which i is an index for the active frequency bands, PD_{norm_i} is the normalized PD value or distribution for the i^{th} active frequency band, Txᵢ is the transmission power level for the i^{th} active frequency band, and Tx_{PDi} is the transmission power level for the normalized PD value or distribution for the i^{th} active frequency band.

### Example RF Exposure Compliance

In certain cases, compliance with an RF exposure limit may be performed as a time-averaged RF exposure compliance evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

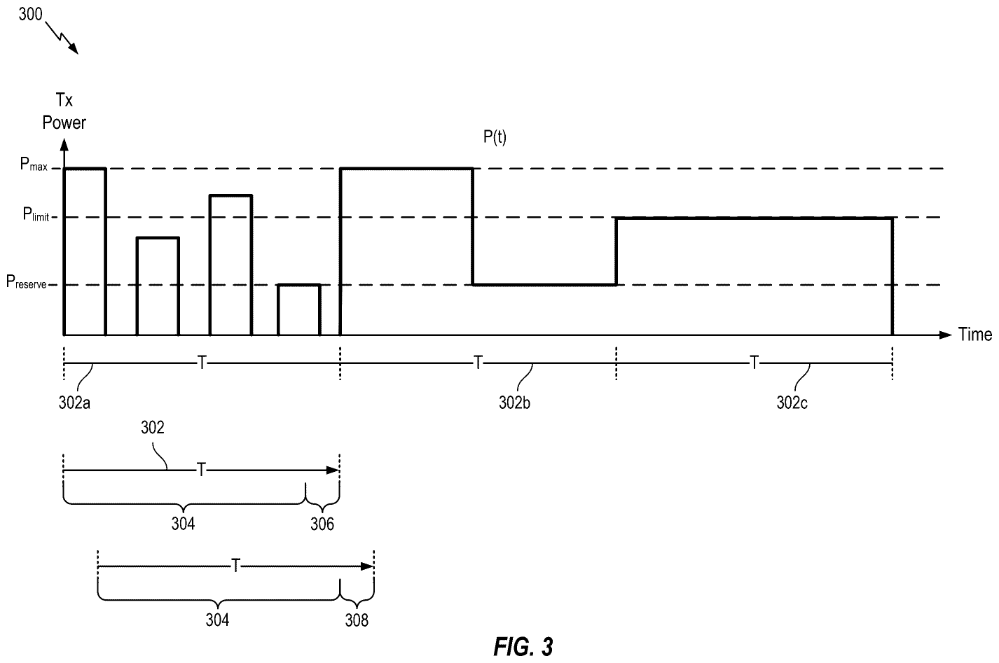

FIG. 3 is a graph 300 of a transmit power over time (P(t)) that varies over a running (e.g., rolling or moving) time window (T) associated with the RF exposure limit. The wireless device (e.g., the wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the time window 302c such that the time-averaged transmit power over the time window (e.g., the time window 302c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target may be selected to be less than the RF exposure limit to account for device uncertainty and/or to meet the RF exposure limit in exposure scenarios when transmitting simultaneously with other radios within the same device that have a different RF exposure controlling mechanism.

In certain cases, an instantaneous transmit power may exceed Pₗᵢₘᵢₜ in certain transmission occasions, for example, as shown in the time window 302a and the time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, PCMAX). In some cases, the wireless device may transmit at a transmit power less than or equal to Pₗᵢₘᵢₜ in certain transmission occasions, for example, as shown in the time window 302a.

In certain cases, a reserve power may be used to enable a continuous transmission within a time window (T) when transmitting above Pₗᵢₘᵢₜ in the time window or to enable a certain level of quality for certain transmissions. As shown in the time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “reserve power level” or “reserve level.”

In the time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the time window 302b. While a single transmit burst is illustrated in the time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure compliance evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 302a, the duty cycle may be greater than 50% of the duration of the time window (T), whereas in the time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

### Example Time-Averaged RF Exposure Evaluation Based on RF Exposure Contribution Information

In certain cases, although antennas may be positioned in different locations across a wireless device, a time-averaging algorithm for RF exposure compliance may assume the peak locations of RF exposure (also referred to as RF exposure hotspots) from all transmit antennas are collocated on the wireless device. Under such an assumption, the total transmit power of all transmit antennas may be limited regardless of the actual exposure scenario (e.g., head exposure, body exposure, or extremity exposure) of separate antennas. For example, suppose the user's hand covers one location on the wireless device, while RF exposure hotspots from specific antennas are not covered by the user's hand. That is, antennas may contribute to the RF exposure differently depending on the location of the exposure. Enforcing the collocated model may lead to limiting the transmit power of specific antennas whose RF exposure hotspots are not actually covered by the user's hand. That is, the assumption that all RF exposure hotspots from transmit antennas are collocated for RF exposure compliance may result in a needlessly low transmit power, which may affect uplink performance such as uplink data rates, uplink carrier aggregation, and/or an uplink connection at the edge of a cell.

Similarly, in cases where antennas are grouped into one or more antenna groups, a time-averaging algorithm for RF exposure compliance may assume all RF exposure hotspots from transmit antennas within a given antenna group are collocated. Under such an assumption, the total transmit power of all transmit antennas within the antenna group may be limited regardless of the actual exposure scenario of separate antennas within the antenna group. For example, the peak locations of RF exposure may not be at the same location for all antennas of an antenna group. Accordingly, enforcing the collocated model for an antenna group may also lead to limiting the transmit power of specific antennas within the antenna group. That is, the assumption that all RF exposure hotspots from transmit antennas within the antenna group are collocated for RF exposure compliance may result in a needlessly low transmit power, which may affect uplink performance such as uplink data rates, uplink carrier aggregation, and/or an uplink connection at the edge of a cell.

In certain examples, a time-averaging RF exposure compliance evaluation that assumes all (or at least some) RF exposure hotspots of antennas are collocated may be represented with the following:

$${\sum }_{i = 1}^{p} [ \frac{1}{Ti} {\int }_{t - Ti}^{t - Δ t} \{ \frac{Tx \cdot pwr \cdot radio \cdot i ( t )}{Plimit \cdot i} \} ] + {\sum }_{i = 1}^{p} [ \frac{Δ t}{Ti} * exp \cdot radio \cdot i ( Δ t ) ] \leq 1. \qquad ( 7 )$$

where p is the number of active radios of the wireless device (e.g., p active radios 1, 2, . . . , p), Ti is the operating time-averaging window for the i^{th} radio, Plimit.i is the transmit power limit of the i^{th} radio, Tx.pwr.radio.i (t) is the transmit power of the i^{th} radio in a prior time interval (e.g., between time instances t-Ti and t-Δt) associated with Ti, and exp.radio.i(Δt) is allowed exposure margin for the it radio in a future time interval (e.g., Δt) associated with Ti. Note, the time-averaging windows may or may not be the same depending on the transmitting frequency of each radio.

Aspects of the present disclosure provide various techniques for determining RF exposure contribution information associated with antennas of a wireless device. The RF exposure contribution information may include, for each antenna, an indication of spatial contribution of RF exposure from the antenna on the RF exposure contributor(s). In some cases, the RF exposure contributor(s) may include each other antenna of the wireless device. In other cases, the RF exposure contributor(s) may include one or more composite RF exposure maps for one or more antennas of the wireless device. In other cases, the RF exposure contributor(s) may include one or more regions of an RF exposure distribution (or map) for the wireless device. In yet other cases, the RF exposure contributor(s) may include one or more surfaces of the wireless device.

In certain aspects, the indications of spatial RF exposure contributions for each antenna may be represented with an RF exposure contribution matrix, which includes a respective contribution factor (or contribution ratio) corresponding to a level of interaction of RF exposure from the antenna on one of the RF exposure contributor(s).

In certain aspects, assuming a wireless device has n antennas, the contribution matrix for each antenna may be a n-by-n square matrix. Each contribution matrix may be based on spatial information obtained from RF exposure distributions associated with the antennas and/or information indicating spatial separation distances between the antennas.

In certain aspects, assuming a wireless device has n antennas and the RF exposure contributors are representative of regions of an RF exposure map, the contribution matrix may be an n-by-m matrix, where m is the number of regions of the RF exposure map.

In certain aspects, assuming a wireless device has n antennas and m surfaces, the contribution matrix may be a n-by-m matrix, where m is the number of surfaces of the wireless device.

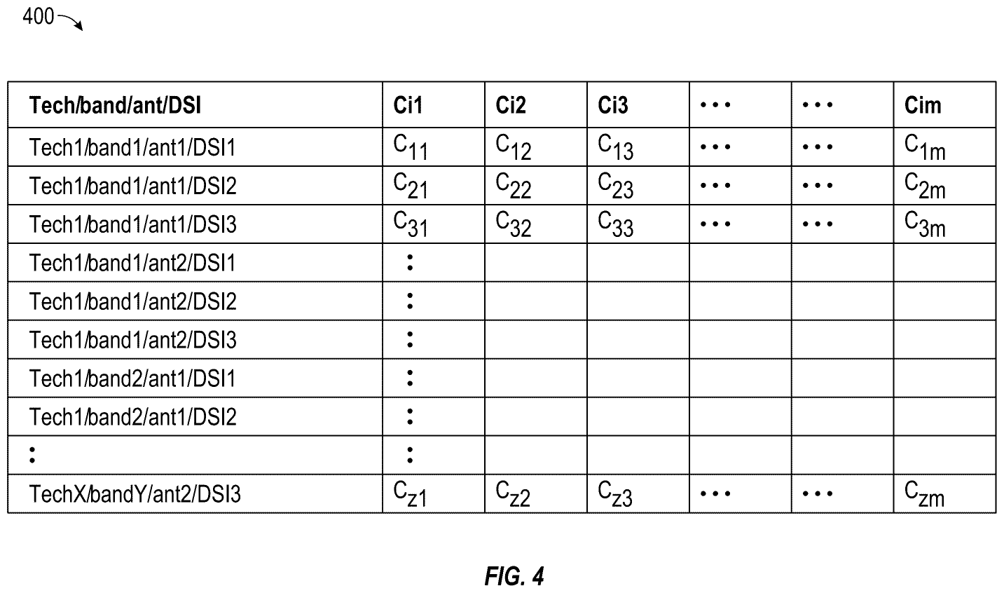

FIG. 4 illustrates an example contribution matrix 400 for a wireless device, according to certain aspects of the present disclosure. The contribution matrix 400 may include a set of contribution factors for each combination of technology/frequency band/antenna/DSI (or, more generally, a transmit scenario). Here, for example, the contribution matrix 400 includes a set of “m” contribution factors for each combination of technology/frequency band/antenna/DSI. In certain aspects, “m” is representative of a number of antennas of the wireless device (e.g., m=n for n antennas of the wireless device). In certain other aspects, “m” is representative of a number of composite RF exposure distributions (or maps) for the wireless device (e.g., m=N composite RF exposure distributions (tech/band/ant/DSI)). In certain other aspects, “m” is representative of a number of regions of an RF exposure distribution(s) (e.g., composite RF exposure distribution) associated with the wireless device (e.g., m=m regions, where m regions may be less than n antennas of the wireless device, greater than n antennas of the wireless device, or equal to n antennas of the wireless device). In certain other aspects, “m” is representative of a number of surfaces of the wireless device (e.g., m=6 for 6 surfaces of the wireless device).

Note, while the contribution matrix 400 depicted in FIG. 4 assumes a two antenna and 3 DSI system with X technologies and Y frequency bands (e.g., for a total of “z” records), note that a contribution matrix generated using the techniques described herein may include any number of antennas, DSIs, technologies, and/or frequency bands. Additionally, note that while many aspects described herein assume the contribution factors may have a value between 0 and 1, in certain aspects, the contribution factors may have a value within another predefined range.

Additionally, note that the contribution matrix 400 is an illustrative example of a contribution matrix and that a contribution matrix may include contribution factors for different transmit scenarios. In certain aspects, for example, the contribution matrix 400 may include both SISO and MIMO entries. For instance, for a 2×2 MIMO configuration, the contribution matrix may indicate configuration factors for all supported antenna pairs. In certain aspects, the contribution matrix 400 may include solely SISO entries. In such aspects, the MIMO entries may be derived using a time-averaging algorithm for RF exposure compliance, based on respective SISO entries of individual antennas part of the MIMO transmission.

As noted, certain aspects described herein provide techniques for performing a time-averaged RF exposure compliance evaluation using the RF exposure contribution information (e.g., contribution matrix 400) generated using the iterative contour approach described herein. For example, a wireless device may evaluate RF exposure compliance based on the RF exposure contribution information, e.g., as part of a time-averaged operation. The wireless device may perform an RF exposure assessment of past RF exposure over a given time window using the RF exposure contribution information described herein to determine a maximum allowable transmit power for a future time interval in the time window. The time-averaged operation may track a normalized RF exposure history over the time window for each radio, and the wireless device may sum the normalized RF exposures of all active radios in simultaneous transmission scenarios. The sum of normalized RF exposure associated with the radios may use the respective RF exposure contribution information associated with each of the antenna(s) for the radios.

The apparatus and methods for performing a time-averaged RF exposure compliance evaluation using the RF exposure contribution information described herein may facilitate improved wireless communication performance in terms of improved signal quality at the receiver, higher throughput, decreased latency, and increased range, as illustrative examples. For example, the time-averaged RF exposure compliance evaluation based on the spatial information of RF exposure contributions among antennas may provide an accurate assessment of the RF exposure occurring at locations across the wireless device allowing the wireless device to determine a higher maximum allowable transmit power limit for certain transmissions.

In certain aspects, the RF exposure contribution information may include, for each antenna, a respective contribution matrix with contribution factors associated with RF exposure contributors. In certain other aspects, the RF exposure contribution information may include, for each antenna within each antenna group, a respective contribution matrix with contribution factors associated with RF exposure contributors for the antenna group.

In certain aspects, the time-averaged RF exposure compliance evaluation based on the RF exposure contribution information described herein may be represented with the following:

$${\sum }_{i = 1}^{p} [ \frac{1}{Ti} {\int }_{t - Ti}^{t - Δ t} \{ \frac{Tx \cdot pwr \cdot radio \cdot i ( t )}{Plimit \cdot i} * [ {C}_{i 1} , {C}_{i 2} , ... , {C}_{im} ] \} ] + {\sum }_{i = 1}^{p} [ \frac{Δ t}{Ti} * exp \cdot radio \cdot i ( Δ t ) * [ {C}_{i 1} , {C}_{i 2} , ... , {C}_{im} ] ] \leq 1. \qquad ( 8 )$$

where p is the number of active radios of the wireless device (e.g., p active radios 1, 2, . . . , p), Ti is the operating time-averaging window for the i^{th} radio, Plimit.i is the transmit power limit of the it radio, Tx.pwr.radio.i (t) is the transmit power of the i^{th} radio in a prior time interval (e.g., t-Δt) associated with Ti, exp.radio.i is allowed exposure margin for the i^{th} radio in a future time interval (e.g., At) associated with Ti, and [Cᵢ₁, Cᵢ₂, . . . , Cᵢₘ] is a set of m contribution factors. In certain aspects, the RF exposure contribution information (e.g., contribution matrix 400) may be generated using the iterative contour approach described herein, each contribution factor representative of a highest level of interaction of another antenna on the antenna(s) for the i^{th} radio, resulting in m=N antennas or in certain aspects, the contribution matrix 400 may be a square matrix. In general, each contribution factor may be representative of a highest level of interaction of another RF exposure contributor on the antenna(s) for the i^{th} radio, such that m=N antennas when the RF exposure contributors are representative of antennas of the wireless device, m=m regions when the RF exposure contributors are representative of regions of an RF exposure map, and m=number of surfaces, when the RF exposure contributors are representative of surfaces of the wireless device. Note, the time-averaging windows may or may not be the same depending on the transmitting frequency of each radio.

The time-averaged RF exposure compliance evaluation in Equation (8) computes exposure consumed in a past regulatory time window—Δt to evaluate the exposure margin available for a future Δt that the radio is allowed to transmit (e.g., Tx.pwr.radio.i(Δt)) while remaining compliant with the regulatory exposure limit. For example, the transmit power of the i^{th} radio in the future Δt may be represented with the following:

$$Tx \cdot pwr \cdot radio \cdot i ( Δ t ) = exp \cdot radio \cdot i ( Δ t ) * Plimit \cdot i \qquad ( 9 )$$

In certain aspects, performing the time-averaged RF exposure compliance evaluation based on RF exposure contribution information may provide a higher transmit power for the i^{th} radio, resulting in higher performance for the i^{th} radio compared to the performance for the i^{th} radio without the RF exposure contribution information. For example, as indicated in Equation (8), the consumed exposure (e.g., Tx.pwr.radio.i (t)/Plimit.i) for the i^{th} radio is multiplied by the corresponding contribution ratio (Cij) and stored. Since contribution ratios are typically ≤1, it follows that the time-averaged consumed exposure may be lower (compared to the time-averaged consumed exposure without contribution factors), resulting in more available margin (while time-averaged exposure remains under regulatory limit) and providing a higher transmit power for the i^{th} radio (compared to the time-averaged RF exposure compliance evaluation without contribution factors).

In certain aspects, performing a time-averaged RF exposure compliance evaluation for RF exposure compliance based on RF exposure contribution information may involve performing an individual time-averaged RF exposure compliance evaluation for each contribution factor within a contribution matrix. For example, assuming the RF exposure contribution information includes a set of m contribution factors within the respective contribution matrix for an antenna of the i^{th} radio, each time-averaged RF exposure compliance evaluation may be represented with the following:

$${\sum }_{i = 1}^{p} [ \frac{1}{Ti} {\int }_{t - Ti}^{t - Δ t} \{ \frac{Tx \cdot pwr \cdot radio \cdot i ( t )}{Plimit \cdot i} * [ {C}_{ij} ] \} ] + {\sum }_{i = 1}^{p} [ \frac{Δ t}{Ti} * exp \cdot radio \cdot ij ( Δ t ) ] \leq 1. \qquad ( 10 )$$

where Cᵢⱼ is the j^{th} contribution factor (e.g., j∈{0, . . . , m}) associated with the antenna for the i^{th} radio.

In certain aspects, the it radio's allowable power to transmit in the future time interval (e.g., Tx.pwr.radio.i(Δt)) may be based on the multiple (e.g., m) time-averaged operations. For example, a respective provisional transmit power limit may be determined using each time-averaged RF exposure compliance evaluation, and the minimum of the provisional transmit power limits may be selected as the i^{th} radio's allowable power to transmit in the future time interval (e.g., Tx.pwr.radio.i(Δt)). By way of example, the allowed exposure margin for the future time interval that complies with all (e.g., m) time-averaged RF exposure compliance evaluations may be represented with the following:

$$exp \cdot radio \cdot i ( Δ t ) = minimum ( \frac{exp \cdot radio \cdot ij ( Δ t )}{{C}_{ij}} , j = 1 , 2 , ... , m ) \qquad ( 11 )$$

In certain aspects, each of the provisional transmit power limits may be power boosted based on a boost factor determined based on the respective contribution factor. For example, the respective allowed transmit power limit computed from each of the multiple time-averaged RF exposure compliance evaluations may be boosted by the inverse of the contribution factor Cᵢⱼ. Here, the allowed exposure margin in the future transmission may be split among the active radios' exposure budgets

$$( e . g . , allowed \cdot exp \cdot budget \cdot radio \cdot a = \frac{Tx \cdot pwr \cdot radio \cdot a ( Δ t )}{Plimit \cdot a} ) .$$

Additionally, since the allowed exposure budget for the future transmission is multiplied by the contribution factor Cᵢⱼ when counting the allowed exposure budget as “consumed exposure” during the time-averaged RF exposure compliance evaluation, the allowed exposure budgets can be boosted using a boost factor Fᵢⱼ, where Fᵢⱼ=1/Cᵢⱼ.

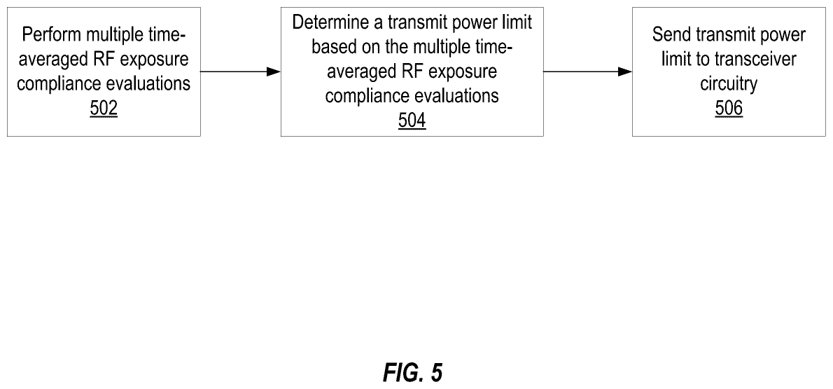

FIG. 5 illustrates an example workflow 500 for a time-averaged RF exposure compliance evaluation based on RF exposure contribution information, according to certain aspects of the present disclosure.

As shown, the workflow 500 may involve, at block 502, performing multiple time-averaged RF exposure compliance evaluations. For example, at block 502, a respective time-averaged RF exposure compliance evaluation may be performed for each contribution factor Cᵢⱼ (or contribution ratio) (e.g., m time-averaged RF exposure compliance evaluations). In certain cases, each time-averaged RF exposure compliance evaluation may include: (i) determining a consumed exposure budget for a prior time interval of a time-averaging window based on the contribution factor Cᵢⱼ (e.g., consumed exposure budget=Cᵢⱼ*RF Tx power report/Pₗᵢₘᵢₜ); (ii) performing a time-averaging operation to determine an allowed exposure margin (or budget) for a future time interval of the time-averaging window; and (iii) determining an allowed transmit power limit based in part on the allowed exposure margins, where the allowed transmit power limit is boosted by the inverse of the contribution factor Cᵢⱼ (e.g., allowed transmit power limit=allowed exposure budget*Pₗᵢₘᵢₜ/Cᵢⱼ), resulting in a higher transmit power for the radio to transmit to obtain higher performance.

The workflow 500 may also involve, at block 504, determining a transmit power limit based on the multiple time-averaged RF exposure compliance evaluations performed in block 502. As noted herein, in certain aspects, determining the transmit power limit may include selecting the minimum allowed transmit power limit for each active radio out of the multiple time-averaged RF exposure compliance evaluations.

The workflow 500 may also involve, at block 506, sending the transmit power limit determined at block 504 to transceiver circuitry. For example, the minimum allowed transmit power limit for each active radio out of the multiple time-averaged RF exposure compliance evaluations may be sent to transceiver circuitry (e.g., the transceiver depicted in FIG. 2) as the power limit for transmission.

### Example Reserve Energy Allocation

As noted, certain wireless devices may be configured to reserve some of the time-averaged RF exposure energy in a time-averaging window. For example, certain wireless devices may be configured with a reserve associated with radios of the wireless device and may split (or allocate) the reserve among the radios when multiple radios are actively transmitting at the same time.

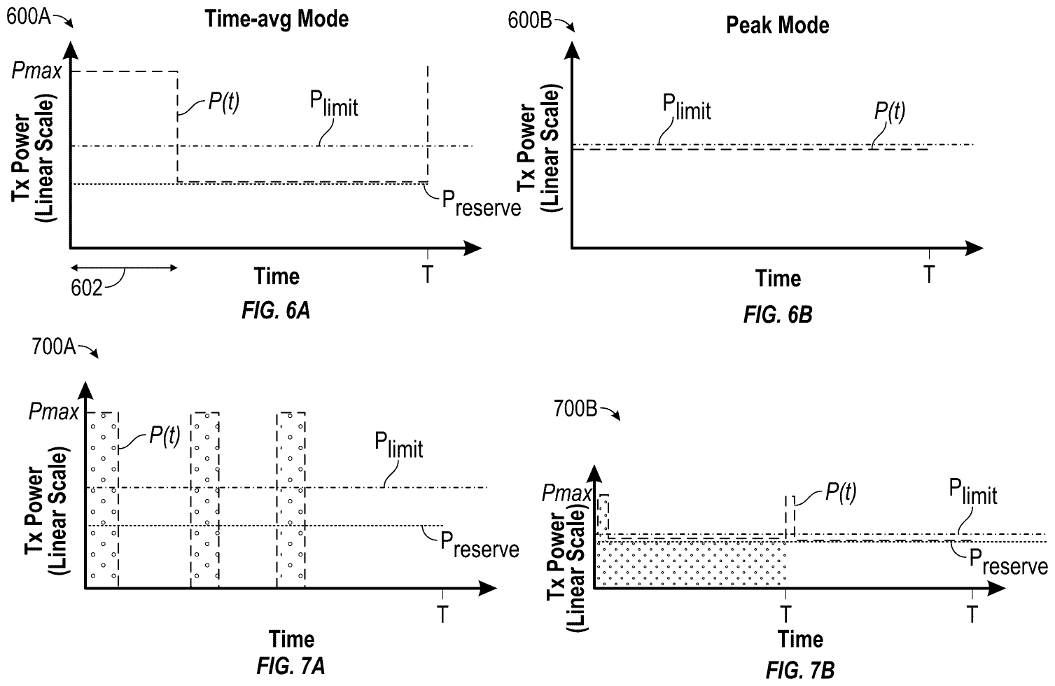

Certain wireless devices may support reserve operation for a time-averaging mode, a peak mode, or a combination thereof. FIG. 6A is a graph 600A illustrating examples of transmit powers over time (P(t)) for a time-averaging mode, and FIG. 6B is a graph 600B illustrating examples of transmit powers over time (P(t)) for a peak mode, in accordance with certain aspects of the present disclosure. In FIG. 6A, Pᵣₑₛₑᵣᵥₑ may be used to reserve transmit power for at least a portion of the time window T for certain transmissions (e.g., control signaling). Additionally, in some cases, the wireless device may transmit at a power that is higher than Pₗᵢₘᵢₜ, but less than or equal to Pₘₐₓ in the time-averaged mode illustrated in the time window 602. In FIGS. 6A and 6B, the total energy over the time window T (e.g., RF exposure energy in one regulatory time window) may be approximately equal to Pₗᵢₘᵢₜ*T. However, in the peak mode illustrated in FIG. 6B, the wireless device transmits at a power that is equal to or lower than Pₗᵢₘᵢₜ.

In some cases, wireless devices may use the time-averaging mode and low reserve operation for short transmissions, such as burst transmissions, as an illustrative example. An illustrative example of low reserve operation for short transmissions is depicted in graph 700A of FIG. 7A. In other cases, wireless devices may use the peak mode and high reserve operation for longer transmissions, such as full-buffer traffic, as an illustrative example. An illustrative example of high reserve operation for long transmissions is depicted in graph 700B of FIG. 7B. In FIGS. 6A, 6B, and 7B, a slight separation between transmit power (P(t)) and either Pᵣₑₛₑᵣᵥₑ or Pₗᵢₘᵢₜ is shown for case of illustration, but it will be understood that P(t) may overlap or be the same, or be slightly below, Pᵣₑₛₑᵣᵥₑ or Pₗᵢₘᵢₜ in these examples.

In certain cases, the reserve power level (e.g., reserve power level=Pₗᵢₘᵢₜ*reserve) may be selected in order to maintain a radio connection with a receiving entity (e.g., AP) at a cell edge. In general, a higher reserve operation may be used to maintain the radio connection for lower Pₗᵢₘᵢₜₛ for certain transmit scenarios (e.g., technology/frequency band/antenna/DSI). However, if Pₘₐₓ is used to maintain the link, then it may be desirable to operate at zero reserve in order to maximize (or at least increase) high power energy duration.

In some cases, wireless device manufacturers (e.g., original equipment manufacturers (OEMs)) may use a predefined (e.g., 50% or some other percentage) reserve level to balance between reserve energy for long transmissions/full-buffer traffic versus high power energy for short/bursty traffic. However, in certain scenarios, it may be desirable to increase the total reserve level. For example, Pₗᵢₘᵢₜₛ may be lowered for a wireless device, as RF exposure evaluation is increasingly performed at lower separation distances (e.g., from 10-15 millimeters (mm) to 0 mm). As such, it may be desirable to increase the reserve to achieve a Pᵣₑₛₑᵣᵥₑ that is sufficient to maintain a radio connection with a receiving entity. In another example, in a multi-transmission scenario, the reserve may be split among active radios, leading to allocation of lower reserve for each active radio. This split in total reserve can cause link failures or lower performance.

As noted, certain time-averaging RF exposure compliance evaluations assume all (or at least some) RF exposure hotspots are collocated due to lack of spatial information. In such time-averaging RF exposure compliance evaluations, allocating a reserve among radios of a wireless device can lead to an unnecessarily low reserve allocation for one or more radios, impacting the performance of the wireless device in terms of reduced throughput, increased latency, reduced RF link quality, and decreased range, as illustrative examples.

By way of example, for a time-averaging RF exposure compliance evaluation performed according to Equation 7 (e.g., without RF exposure contribution information), the allowed exposure margin for the i^{th} radio for a future time interval in a time-averaging window (exp.radio.i.(Δt)) may be represented as:

$$exp \cdot radio \cdot i ( Δ t ) = reserve \cdot i + extra \cdot margin \cdot i \qquad ( 12 )$$

$$where reserve \cdot i = \frac{{a}_{i}}{{\sum }_{i = 1}^{p} {a}_{i}} * total \cdot reserve and total \cdot reserve = {\sum }_{i = 1}^{p} reserve \cdot i .$$

Thus, for such time-averaging RF exposure compliance evaluations (e.g., Equation 7), the total reserve for all p active radios may be split according to the following:

$$total \cdot reserve = {\sum }_{i = 1}^{p} reserve \cdot i = {\sum }_{i = 1}^{p} ( \frac{{a}_{i}}{{\sum }_{i = 1}^{p} {a}_{i}} * total \cdot reserve ) \qquad ( 13 )$$

where aᵢ is a reserve split parameter (or coefficient) for the i^{th} radio, and the total extra margin for all p active radios may be split according to the following:

$$total \cdot extra \cdot margin ( Δ t ) = {\sum }_{i = 1}^{p} extra \cdot margin \cdot i = {\sum }_{i = 1}^{p} ( \frac{{b}_{i}}{{\sum }_{i = 1}^{p} {b}_{i}} * total \cdot extra \cdot margin ( Δ t ) ) \qquad ( 14 )$$

where bᵢ is an extra margin split parameter (or coefficient) for the i^{th} radio. Note that the reserve split parameters aᵢ may or may not be the same as the extra margin split parameters bᵢ. Here, as the number of simultaneous radios increases (e.g., p increases), the allocated reserve portion to each radio may decrease, leading to dropped links.

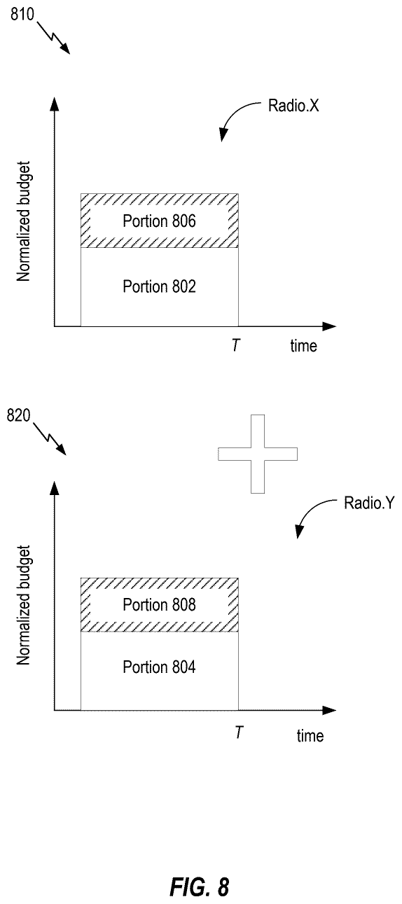

FIG. 8 depicts graphs 810 and 820 illustrating example allocations of reserve for a first radio (e.g., radio.x) and a second radio (e.g., radio.y), respectively, for a 2-radio transmission scenario. As shown in graph 810, the first radio may be allocated a portion 802 of total reserve and a portion 806 of total reserve over a time-averaging window T. Similarly, as shown in graph 820, the second radio may be allocated a portion 804 of total reserve and a portion 808 of total reserve over a time-averaging window. The portions 802, 804 may be representative of a baseline allocation of total reserve over the time-averaging window. The portions 806, 808 may be representative of extra margin (e.g., an additional portion of the total reserve above the baseline allocation) that is available to the first radio and the second radio, respectively, over the time-averaging window. The allocation of the portions 802, 804, 806, and/or 808 may vary dynamically based on one or more operational factors, such as usage conditions and reserve split parameters, as illustrative examples.

For example, in FIG. 8, the allocation for portion 802 may be based on aₓ*total reserve, the allocation for portion 804 may be based on a_{y}*total reserve, the allocation for portion 806 may be based on bₓ*extra margin, and the allocation for portion 808 may be based on b_{y}*extra margin. In such an example, the consumed reserve over the time-averaging window (consumed.reserve) may be represented with the following:

$$consumed \cdot reserve = {\sum }_{i = 1}^{p} ( \frac{{a}_{i}}{{\sum }_{i = 1}^{p} {a}_{i}} * total \cdot reserve ) \qquad ( 15 )$$

Note, in FIG. 8, the total extra margin=1—all consumed total reserve. Additionally, for the sake of clarity, FIG. 8 assumes

$${\sum }_{i = 1}^{p} {a}_{i} = 1 and {\sum }_{i = 1}^{p} {b}_{i} = 1.$$

Note that, in FIG. 8, the respective durations of the portions 802, 804, 806, and 808 are conceptual and are not intended to represent precise time spans or scaling. For example, the duration of portions 806 and 808 may be shorter or longer than the duration of portions 802 and 804, respectively. In some cases, a reserve portion 806 and/or 808 may be applied for a subset of the time window associated with the reserve portion 802 and/or 804, such as when additional reserve is utilized during brief high-power transmission events. The relative timing and length of the portions in FIG. 8 are therefore illustrative and may vary based on implementation-specific parameters, operating conditions, and/or regulatory specifications.

### Example Reserve Energy Allocation Based on RF Exposure Contribution Information

Certain aspects of the present disclosure provide apparatus and methods for allocating reserve energy among radios of a wireless device based on RF exposure contribution information associated with antennas for the radios of the wireless device. The RF exposure contribution information may include, for each antenna, a respective indication of spatial contribution of RF exposure from the antenna on each other antenna of the wireless device. In certain aspects, the indications of spatial RF exposure contributions for each antenna may be represented with an RF exposure contribution matrix, which includes a respective contribution factor (or contribution ratio) Cᵢⱼ corresponding to a level of interaction of RF exposure from the antenna on an RF exposure contributor. In certain aspects, the RF exposure contributors may be representative of antennas. In certain other aspects, the RF exposure contributors may be representative of regions of an RF exposure map. In certain other aspects, the RF exposure contributors may be representative of surfaces of the wireless device.

In certain aspects, a reserve level for each of the radios of the wireless device may be determined based at least in part on the RF exposure contribution information. Signals may be transmitted using one or more of the radios at a transmit power determined based at least in part on an RF exposure limit associated with each of the radios and the reserve level for each of the radios.

The apparatus and methods for allocating reserve energy among radios based on RF exposure contribution information associated with antennas of a wireless device may facilitate improved wireless communication performance in terms of improved signal quality at the receiver, higher throughput, decreased latency, and increased range, as illustrative examples. For example, in time-averaging RF exposure compliance evaluations that assume all (or at least some) RF exposure hotspots are collocated (e.g., Equation 7), the total reserve may be split among active transmission scenarios using reserve split parameters a₁, a₂, . . . , aₚ, for ‘p’ number of active radios, such that a₁+a₂+ . . . +aₚ=1, and each i^{th} active radio gets reserve=aᵢ*total.reserve. On the other hand, in time-averaging RF exposure compliance evaluations that use spatial information from RF exposure contribution information (e.g., Equation 8), the total reserve may be split using reserve split parameters a₁, a₂, . . . , aₚ, for ‘p’ number of active radios, but the sum of the reserve split parameters can be greater than 1. That is, Σᵢaᵢ≥1 as RF exposure hotspots are not collocated, but are based on spatial coefficients (e.g., contribution parameters).

Here, a₁*[Cᵢⱼ]+a₂*[C₂ⱼ]+a₃*[C₃ⱼ]+ . . . +aₚ*[Cₚⱼ]=1, where Cᵢⱼ<=1. Therefore, Σᵢaᵢ>1, which means that the total reserve for simultaneous radios=Σᵢ(aᵢ*total.reserve)>total.reserve. Accordingly, the radios of the wireless device may be allocated more total reserve in a time-averaging RF exposure compliance evaluation based on RF exposure contribution information (e.g., Equation 8) than in a time-averaging RF exposure compliance evaluation without RF exposure contribution information (e.g., Equation 7).

In certain aspects, for a given desired total reserve, a time-averaging RF exposure compliance evaluation may solve the “second” term

$$( e . g . , {\sum }_{i = 1}^{p} [ \frac{Δ t}{Ti} * exp \cdot radio \cdot i ( Δ t ) * [ {C}_{i 1} , {C}_{i 2} , ... , {C}_{im} ] ] )$$

in Equation 8 to ensure that the total reserve is preserved for the time-averaging window. For example, the time-averaging RF exposure compliance evaluation (e.g., Equation 8) may allocate at least a portion of the total reserve (e.g., aᵢ*total.reserve for i^{th} radio). Any extra margin that is allocated may be used to transmit at a transmission power level higher than the reserve level.

By way of example, with reference to FIG. 5, at block 502, a respective time-averaged RF exposure compliance evaluation may allocate the desired reserve (e.g., split from total reserve) for each active radio, and then provide any leftover ‘high power’ margin to all active radios. Here, when the i^{th} radio transmits at the i^{th} radio's assigned reserve level, the consumed exposure report for each active radio for the past time window may be stored by multiplying with the corresponding Cᵢⱼ factor (where ‘i’ is tech/band/ant/DSI index of active radio and ‘j’ represents contribution factors (or ratios) 1,2 . . . m). Typically, 0<=Cᵢⱼ<=1, therefore, the consumed reserve may be lower than the assigned reserve. Thus, the assigned reserve can be increased using contribution factors Cᵢⱼ for active radios.

As noted, due to the Cᵢⱼ factors providing spatial information, the time-averaged RF exposure compliance evaluation may provide more reserve margin and also more extra margin compared to a time-averaged RF exposure compliance evaluation without spatial information. Consider an illustrative 2-radio transmission scenario with 2 contribution factors of [1 0] for the first radio (e.g., radio 1) and [0 1] for the second radio (e.g., radio 2). In this scenario, each radio may be allocated 100% margin (e.g., a higher reserve and higher extra margin as Cᵢⱼ shows no overlap in exposures).

The present disclosure provides various techniques for allocating the reserve and extra margin among radios of a wireless device.

In certain aspects, a time-averaging RF exposure compliance evaluation based on RF exposure contribution information (e.g., Equation 8) may allocate a respective portion of the total reserve to each radio based on a respective reserve split parameter (e.g., aᵢ) associated with the radio. In some cases, the total reserve may be allocated equally among the radios (e.g., similar to Equation 13). For example, the respective allocated reserve for the i^{th} radio may be represented as:

$$reserve \cdot i = \frac{{a}_{i}}{{\sum }_{i = 1}^{p} {a}_{i}} * total \cdot reserve \qquad ( 16 )$$

In certain aspects, allocating the total reserve among the radios according to Equation 16 may significantly increase the amount of extra margin available for the radios (e.g., for high power transmissions). For example, due to the contribution factor Cᵢⱼ in the “first” term of Equation 10

$$( {e}_{e} g . , {Σ}_{i = 1}^{p} [ \frac{1}{T i} {\int }_{t - Ti}^{t - Δ t} \{ \frac{Tx . pwr . radio . i ( t )}{Plimit . i} * [ {C}_{i j} ] \} ] ) ,$$

the consumed reserve in a time-averaging RF exposure compliance evaluation according to Equation 8 may be lower compared to a time-averaging RF exposure compliance evaluation according to Equation 7, providing additional extra margin for the radios. For example, the consumed reserve may be equal to the highest consumed reserve out of the m time-averaging RF exposure compliance evaluations (e.g., Equation 10) and may be represented with the following:

$$consumed . reserve = maximum \{ {\sum }_{i = 1}^{p} ( \frac{{a}_{i}}{{Σ}_{i = 1}^{p} {a}_{i}} * total . reserve * {C}_{ij} ) , j = 1 , 2 , … m \} \leq total . reserve , as \frac{{a}_{i}}{{Σ}_{i = 1}^{p} {a}_{i}} \leq 1 and {C}_{i j} \leq 1 \qquad ( 17 )$$

Referring to FIG. 8, in certain aspects, the total reserve may be allocated according to Equation 16, and the consumed reserve may be determined according to Equation 17. In some such aspects, the allocation for portion 802 may be based on aₓ*total reserve*Cₓⱼ, and the allocation for portion 804 may be based on a_{y}*total reserve*C_{yj}, where Cₓⱼ is the contribution parameter for the first radio and C_{yj} is the contribution parameter for the second radio. Additionally, the allocation for portion 806 may be based on bₓ*total extra margin, and the allocation for portion 808 may be based on b_{y}*total extra margin. In certain aspects, the total extra margin that is available when allocating reserve according to Equation 16 may be larger than the total extra margin that is available when allocating reserve according to Equation 13.

In certain aspects, the consumed reserve when allocating reserve according to Equation 17 may be lower than the consumed reserve when allocating reserve according to Equation 16. For example, if the allocated reserve is boosted by factor fj, such that consumed reserve

$${\sum }_{i = 1}^{p} ( fj * \frac{{a}_{i}}{{Σ}_{i = 1}^{p} {a}_{i}} * total . reserve * {C}_{ij} ) = total . reserve , then fj * total . reserve * {\sum }_{i = 1}^{p} ( \frac{{a}_{i}}{{Σ}_{i = 1}^{p} {a}_{i}} * {C}_{ij} ) = total . reserve , i . e . , fj \frac{{Σ}_{i = 1}^{p} {a}_{i}}{{Σ}_{i = 1}^{p} ( {a}_{i} * {C}_{ij} )} .$$

Therefore, assigned reserve for the i^{th} radio in j^{th} time-averaged RF exposure compliance evaluation may be given by

$$fj * \frac{{a}_{i}}{{Σ}_{i = 1}^{p} {a}_{i}} * total . reserve = \frac{{a}_{i}}{{Σ}_{i = 1}^{p} ( {a}_{i} * {C}_{ij} )} * total . reserve$$

and the consumed reserve may be given by

$$= \frac{{a}_{i} * {C}_{ij}}{{Σ}_{i = 1}^{p} ( {a}_{i} * {C}_{ij} )} * total . reserve ,$$

such that the total consumed reserve for j^{th} time-averaged RF exposure compliance evaluation is

$${\sum }_{i = 1}^{p} ( \frac{{a}_{i} * {C}_{ij}}{{Σ}_{i = 1}^{p} ( {a}_{i} * {C}_{ij} )} * total . reserve ) = total . reserve .$$

Thus, the consumed reserve when allocating reserve according to Equation 17 may be represented with the following:

$$consumed . reserve = {\sum }_{i = 1}^{p} ( \frac{{a}_{i}}{{Σ}_{i = 1}^{p} ( {a}_{i} * {C}_{ij} )} * total . reserve * {C}_{ij} ) = total . reserve \qquad ( 18 )$$

and allocated reserve for the i^{th} radio in the j^{th} (out of 1 to m) time-averaged RF exposure compliance evaluation may be represented with

$$\frac{{a}_{i}}{{Σ}_{i = 1}^{p} ( {a}_{i} * {C}_{ij} )} * total . reserve ,$$

while the consumed reserve for the i^{th} radio in the j^{th} time-averaged RF exposure compliance evaluation may be represented with

$$\frac{{a}_{i}}{{Σ}_{i = 1}^{p} ( {a}_{i} * {C}_{ij} )} * total . reserve * {C}_{ij} .$$

In certain aspects, a time-averaging RF exposure compliance evaluation based on RF exposure contribution information (e.g., Equation 8) may allocate a respective portion of the total reserve to each radio based at least in part on the respective contribution factor Cᵢⱼ associated with the radio. In certain cases, allocating reserve portions based on RF exposure contribution information may allow the time-averaging RF exposure compliance evaluation (e.g., Equation 8) to operate each radio at a total consumed reserve level (after applying the respective contribution factor for the radio) that is equal to the total reserve level of the time-averaging RF exposure compliance evaluation in Equation 7. In such aspects, the respective allocated reserve for the i^{th} radio in j^{th} time-averaged RF exposure compliance evaluation may be represented as

$$reserve . = {A}_{ij} * total . reserve \qquad ( 19 a )$$

where Aᵢⱼ is the reserve split parameter for the i^{th} radio. Here, allocated reserve includes the contribution factor (in essence, the allocated reserve is similar to consumed reserve), and the assigned reserve (e.g., assigned exposure budget) is boosted using the boost factor Fᵢⱼ, where Fᵢⱼ=1/Cᵢⱼ (see Equation 11) such that

$$assigned . reserve ( i , j ) = {F}_{ij} * allocated . reserve ( i , j ) = \frac{{A}_{ij}}{{C}_{ij}} * total . reserve \qquad ( 19 b )$$

In certain aspects, the reserve split parameter for the i^{th} radio is in proportion to the respective contribution factor for the i^{th} radio. For example, in some such aspects, the reserve split parameter for the i^{th} radio may be represented with the following (as determined by equating Equation 18 and Equation 19a):

$${A}_{ij} = \frac{{a}_{i} * {C}_{ij}}{{Σ}_{i = 1}^{p} ( {a}_{i} * {C}_{ij} )} \qquad ( 20 )$$

Note, however, that Equation 20 is an illustrative example and that Aᵢⱼ can use any variation of contribution parameters, e.g., according to the following:

$${A}_{ij} = f ( {C}_{ij} ) \qquad ( 21 )$$

With reference again to FIG. 8, in certain aspects, the total reserve may be allocated according to Equation 19a, and the consumed reserve may be determined according to Equation 18. In some such aspects, the allocation for portion 802 may be based on Aₓⱼ*total reserve, and the allocation for portion 804 may be based on A_{yj}*total reserve, where Aₓⱼ is the reserve split parameter for the first radio and A_{yj} is the reserve split parameter for the second radio. Additionally, the allocation for portion 806 may be based on Bₓⱼ*total extra margin, and the allocation for portion 808 may be based on B_{yj}*total extra margin, where Bₓⱼ is the extra margin split parameter for the first radio and B_{yj} is the extra margin split parameter for the second radio. In certain aspects described below, the extra margin split parameter Bᵢⱼ may be represented with Equation 23 or Equation 24. In certain aspects, the total extra margin that is available when allocating reserve according to Equation 19a may be larger than the total extra margin that is available when allocating reserve according to Equation 13 or Equation 16.

In certain aspects, when assigning reserve according to Equation 19b, if there are radios whose requested reserve was not satisfied, then certain aspects may allow for assigning at least some portion of excess reserve for radios who met their requested reserve target during assignment to one or more of the unsatisfied radios, so that the unsatisfied radios can be allocated additional reserve. More specifically, if the assigned reserves for one or more radios are below the desired/requested reserve (e.g., depending on network condition, request to close the link, faster data transfer, etc.), then the excess reserve assigned beyond the desired/requested reserve for some radios can be reduced to satisfy desired/requested reserve for unmet radios.

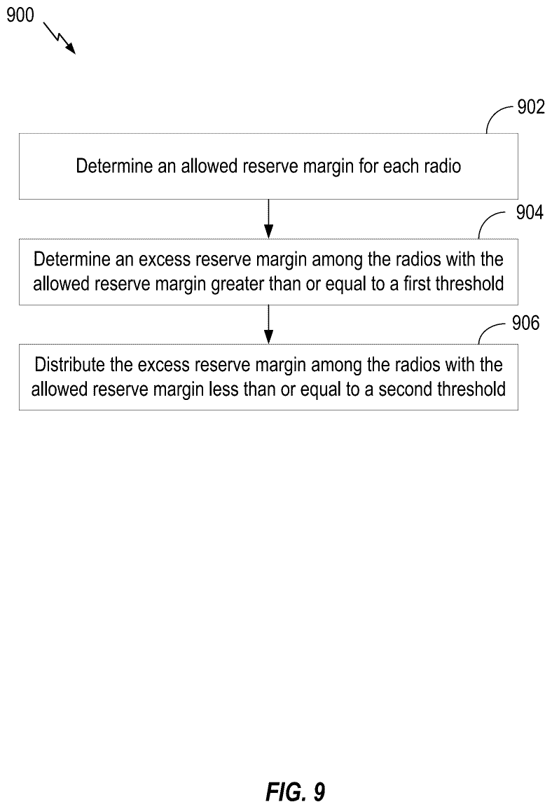

FIG. 9 is a flow diagram illustrating example operations 900 for allocating excess reserve among radios of a wireless device. The operations 900 may be performed, for example, by a wireless device (e.g., the UE 120a).

The operations 900 may optionally begin, at block 902, where the wireless device may determine an allowed reserve margin for each radio. For example, the wireless device may set an assigned reserve for the i^{th} radio in a j^{th} time-averaging RF exposure compliance evaluation according to Equation 19a.

At block 904, the wireless device may determine an excess reserve margin among the radios with the allowed reserve margin greater than or equal to a first threshold.

At block 906, the wireless device may distribute the excess reserve margin among the radios with the allowed reserve margin less than or equal to a second threshold. In certain aspects, the distribution may be based on a respective priority for each radio. For example, one or more first radios may be allocated an amount of reserve that exceeds a respective reserve target for the one or more first radios, and one or more second radios may be allocated an amount of reserve that is below the respective reserve target for the one or more second radios. If any of the radios get allocated an exposure margin less than the target reserve level, it may be desirable to take excess margin from radios that receive more than their reserve target and re-distribute the excess margin to radios that have unmet reserve targets.

In certain aspects, performing the operations in block 904 may involve:

```
For i = 1 to number of active radios
  IF assigned.reserve(i, j) > desired.reserve(i)
    excess.margin(j)
        = excess.margin(j) + {desired.reserve(i)
        − assigned.reserve(i, j);
      assigned.reserve(i, j) = desired.reserve(i)
```

In certain aspects, performing the operations in block 906 may involve:

```
For i = 1 to number of active radios (from highest priority radio to lowest
priority radio)
  IF assigned.reserve(i, j) < desired.reserve(i)
      temp = excess.margin(j);
      excess.margin(j) = max{0, temp − (desired.reserve(i) −
assigned.reserve(i, j))};
    assigned.reserve(i, j) = min{desired.reserve(i), temp +
assigned.reserve(i, j)};
```

In certain aspects, the operations 900 may further include re-distributing leftover excess margin back to the respective assigned reserve for one or more of the radios based on radio priority. For example, re-distributing the leftover excess margin may involve:

```
IF excess · margin(j) > 0 (by this step, all assigned reserves match
desired · reserves(i))
  For i = 1 to number of active radios (from highest priority radio to lowest
priority radio)
  $IF assigned \cdot reserve ( i , j ) < \frac{{a}_{i}}{{\sum }_{i = 1}^{p} ( {a}_{i} * {C}_{i j} )} * total \cdot reserve$
      temp = excess · margin(j);
  $excess \cdot margin ( j ) = max \{ 0 , temp - ( \frac{{a}_{i}}{{\sum }_{i = 1}^{p} ( {a}_{i} * {C}_{i j} )} * total \cdot reserve - assigned \cdot reserve ( i , j ) ) \} ;$
  $assigned \cdot reserve ( i , j ) = min \{ \frac{{a}_{i}}{{\sum }_{i = 1}^{p} ( {a}_{i} * {C}_{i j} )} * total \cdot reserve , temp + assigned \cdot reserve ( i , j ) \} ;$
```

In certain aspects, when allocating reserve according to Equation 19a, unexpected behavior may occur if Cᵢⱼ=0→Aᵢⱼ=0. In particular, when Cᵢⱼ=0→Aᵢⱼ=0, the determination of the allowed exposure margin in Equation 11 may involve a divide-by-zero operation. Additionally, in scenarios where there is no extra margin left, then exp.radio.ij(Δt)=allocated reserve given in Equation 19a=Aᵢⱼ*total.reserve=0. So,

$$assigned exposure margin = \frac{exp . ra dio . ij ( Δ t )}{{c}_{ij}} = assigned . reserve = \frac{0}{0} . \qquad Equation 19 b )$$

To avoid such unexpected behavior, a small parameter “g” may be added to Cᵢⱼ, such that Cᵢⱼ is replaced with (Cᵢⱼ+g). With the addition of the parameter g, when there is no extra margin, the term

$$\frac{exp . radio . ij ( Δ t )}{{c}_{ij}}$$

in Equation 11 may be expressed as

$$\frac{exp \cdot radio \cdot ij ( Δ t )}{{C}_{ij}} = \frac{\frac{{a}_{i} * ( {{C}_{ij}}_{{+ g}^{}} )}{{\sum }_{i = 1}^{p} ( {a}_{i} * ( {C}_{ij} + g ) )} * total \cdot reserve}{( {C}_{ij} + g )} = \frac{{a}_{i} * total \cdot reserve}{{\sum }_{i = 1}^{p} ( {a}_{i} * ( {C}_{ij} + g ) )} .$$

However, in some cases,

$$\frac{{a}_{i} * total \cdot reserve}{{\sum }_{i = 1}^{p} ( {a}_{i} * ( {C}_{ij} + g ) )}$$

may be a small value and may limit the final assigned value of exp.radio.i(Δt) due to the minimum operation in Equation 11.

Accordingly, certain aspects may add a small parameter “g1” to contribution parameters Cᵢⱼ during reserve allocation, and add a small parameter “g2” to contribution parameters Cᵢⱼ during boost operations (e.g., Equation 11). The parameter g2 may be less than the parameter g1. With parameter “g1,” the respective allocated reserve for the i^{th} radio may be represented with (modification of Equation 19a):

$$reserve \cdot i = {A}_{ij} * total \cdot reserve = \frac{{a}_{i} * ( {C}_{ij} + g 1 )}{{\sum }_{i = 1}^{p} ( {a}_{i} * ( {C}_{ij} + g 1 ) )} * total \cdot reserve \qquad ( 21 )$$

and with the parameter “g2,” the allowed exposure margin (and boost operation) that complies with all time-averaged RF exposure compliance evaluations may be represented with:

$$exp \cdot radio \cdot i ( Δ t ) = minimum ( \frac{exp \cdot radio \cdot ij ( Δ t )}{{C}_{ij} + g 2} , j = 1 , 2 , … , m ) \qquad ( 22 )$$

With Equations 21 and 22, when there is no extra margin left,

$$\frac{exp \cdot radio \cdot ij ( Δ t )}{{C}_{ij}} = \frac{\frac{{a}_{i} * ( {C}_{ij} + g 1 )}{{\sum }_{i = 1}^{p} ( {a}_{i} * ( {C}_{ij} + g 1 ) )} * total \cdot reserve}{( {C}_{ij} + g 2 )} = \frac{( {C}_{ij} + g 1 )}{( {C}_{ij} + g 2 )} * \frac{{a}_{i} * total \cdot reserve}{{\sum }_{i = 1}^{p} ( {a}_{i} * ( {C}_{ij} + g 1 ) )} ,$$

may result in a high value (depending on g1/g2) to make this expression inconsequential in the minimum operation in Equation 22 (e.g., assuming g2<<g1).

In certain aspects, a time-averaging RF exposure compliance evaluation based on RF exposure contribution information (e.g., Equation 8) may allocate extra margin to each radio based at least in part on the respective contribution factor Cᵢⱼ associated with the radio. For example, in some cases, the extra margin split parameter (Bᵢⱼ) for the i^{th} radio may be in proportion to the respective contribution factor for the i^{th} radio and may be represented as:

$${B}_{ij} = \frac{{b}_{i} * {C}_{ij}}{{\sum }_{i = 1}^{p} ( {b}_{i} * {C}_{ij} )} \qquad ( 23 )$$

Note, however, that Equation 23 is an illustrative example and that Bᵢⱼ can use any variation of contribution parameters, e.g., according to the following:

$${B}_{ij} = h ( {C}_{ij} ) \qquad ( 24 )$$

In such aspects, for the j^{th} time-averaging RF exposure compliance evaluation (e.g., Equation 10) the total extra margin may be allocated according to the following:

$$total \cdot extra \cdot margin ( j , Δ t ) = {\sum }_{i = 1}^{p} extra \cdot margin \cdot ij = {\sum }_{i = 1}^{p} ( \frac{{b}_{i} * {C}_{ij}}{{\sum }_{i = 1}^{p} ( {b}_{i} * {C}_{ij} )} * total \cdot extra \cdot margin ( j , Δ t ) ) \qquad ( 25 )$$

As noted, the allocated reserve according to Equation 17 is boosted by factor fj, such that consumed reserve

$${\sum }_{i = 1}^{p} ( fj * \frac{{a}_{i}}{{\sum }_{i = 1}^{p} {a}_{i}} * total \cdot reserve * {C}_{ij} ) = total \cdot reserve , then fj * total \cdot reserve * {\sum }_{i = 1}^{p} ( \frac{{a}_{i}}{{\sum }_{i = 1}^{p} {a}_{i}} * {C}_{ij} ) = total \cdot reserve , i . e . , fj = \frac{{\sum }_{i = 1}^{p} {a}_{i}}{{\sum }_{i = 1}^{p} ( {a}_{i} * {C}_{ij} )} .$$

Similarly, the allocated extra margin according to Equation 23 and Equation 25 were boosted by factor

$$gj = \frac{{\sum }_{i = 1}^{p} {b}_{i}}{{\sum }_{i = 1}^{p} ( b * {C}_{ij} )} .$$

These boosted factors represent the gain ratio of reserve exposure margin achieved by using RF exposure contribution information to the reserve exposure margin without using RF exposure contribution information. In a simplistic scenario, where the reserve split parameters a₁, a₂, . . . , aₚ, for ‘p’ number of active radios are all equal, i.e.,

$${a}_{i} = \frac{1}{p} ,$$

such that a₁+a₂+ . . . +aₚ=1, and the extra margin split parameters b₁, b₂, . . . , bₚ, for ‘p’ number of active radios are all equal, i.e.,

$${b}_{i} = \frac{1}{p} ,$$

such that b₁+b₂+ . . . +bₚ=1, then

$$fj = \frac{p}{{\sum }_{i = 1}^{p} ( {C}_{ij} )} = gj = \frac{p}{{\sum }_{i = 1}^{p} ( {C}_{ij} )} .$$

Since the allowed exposure margin (e.g., sum of assigned reserve and assigned extra margin) is the minimum of all (e.g., m) time-averaged RF exposure compliance evaluations as described in Equation 11, the gain ratio of reserve exposure margin achieved by using RF exposure contribution information to the reserve exposure margin without using RF exposure contribution information may be represented with the following:

$$gain \cdot ratio \cdot from \cdot contribution \cdot matrix = minimum ( \frac{p}{{\sum }_{i = 1}^{p} ( {C}_{ij} )} , j = 1 , 2 , … , m ) \qquad ( 26 )$$

Consider an illustrative 2-radio transmission scenario with 2 contribution factors of [1 0] for the first radio (e.g., radio 1) and [0 1] for the second radio (e.g., radio 2). Further assume that there is a 50% total reserve and 50% extra margin available for high power transmission.

In this aforementioned scenario, a time-averaging RF exposure compliance evaluation performed according to Equation 7 (e.g., without RF exposure contribution information) may operate the first radio and the second radio at equal allocations for reserve and extra margin (e.g., 25% reserve and 25% extra margin).

Continuing with the aforementioned scenario, assuming a time-averaging RF exposure compliance evaluation performed according to Equation 8 allocates reserve in accordance with Equation 16, the first radio and the second radio may each be allocated a same amount of reserve (e.g., same percentage of reserve, such as 25% reserve). However, in this scenario, since the contribution factors for the first radio and the second radio show no overlap in the RF exposures between the first radio and second radio, the time-averaging RF exposure compliance evaluation may operate at the reserve level of one of the radios (e.g., 25% reserve) as opposed to a total reserve level (e.g., 50% reserve), providing an extra margin (e.g., 75% extra margin) that may be applied to both the first radio and the second radio.

Continuing with the aforementioned scenario, assuming a time-averaging RF exposure compliance evaluation performed according to Equation 8 allocates reserve in accordance with Equation 17, the allocated reserve for radio 1 and radio 2 may be equal to the total reserve depending on the contribution factors. In this example, since the contribution factors for the first radio and the second radio show no overlap in the RF exposures between the first radio and second radio, then the reserve for radio 1 may be to the reserve for radio 2 (e.g., reserve for radio 1 may be equal to 50% and the reserve for radio 2 may be equal to 50%). Similarly, an extra margin equal to the total extra margin may be available for both radios depending on the contribution factors. In this example, since the contribution factors for the first radio and the second radio show no overlap in the RF exposures between the first radio and second radio, the extra margin for radio 1 may be equal to the extra margin for radio 2 (e.g., extra margin for radio 1 may be equal to 50% and the extra margin for radio 2 may be equal to 50%).

Continuing with the aforementioned scenario, in an illustrative p=2 radio transmission scenario with m=2 contribution factors of [1 0] for the first radio and [0 1] for the second radio, Equation 26 provides the

$$gain \cdot ratio \cdot from \cdot contribution \cdot matrix = minimum ( \frac{2}{( 1 + 0 )} , \frac{2}{( 0 + 1 )} ) = 2 ,$$

which indicates that total exposure margin obtained from time-averaging RF exposure compliance evaluation performed according to Equation 8 with RF exposure contribution information (e.g., sum of all exposures=200%) is 2 times that of total exposure margin obtained from time-averaging RF exposure compliance evaluation performed according to Equation 7 without RF exposure contribution information (e.g., sum of all exposures=100%).

With reference to FIG. 8, in certain aspects, when the time-averaging RF exposure compliance evaluation is performed according to Equation 7 (e.g., without RF exposure contribution information), the portions 802, 804, 806, and 808 may be approximately equal.

In certain aspects, when the time-averaging RF exposure compliance evaluation is performed according to Equation 8 and allocates reserve in accordance with Equation 16, the portion 802 and the portion 804 may be approximately equal, providing extra margin that may be applied to both the first radio and the second radio (e.g., the portion 806 and the portion 808 may be approximately equal).

In certain aspects, when the time-averaging RF exposure compliance evaluation is performed according to Equation 8 and allocates reserve in accordance with Equation 17, the portions 802 and 804 may be approximately equal to the total reserve depending on the contribution factors for the first radio and the second radio. Additionally, the portions 804 and 806 may be approximately equal to the total extra margin available for both the first radio and the second radio.

### Example Operations for Wireless Communications

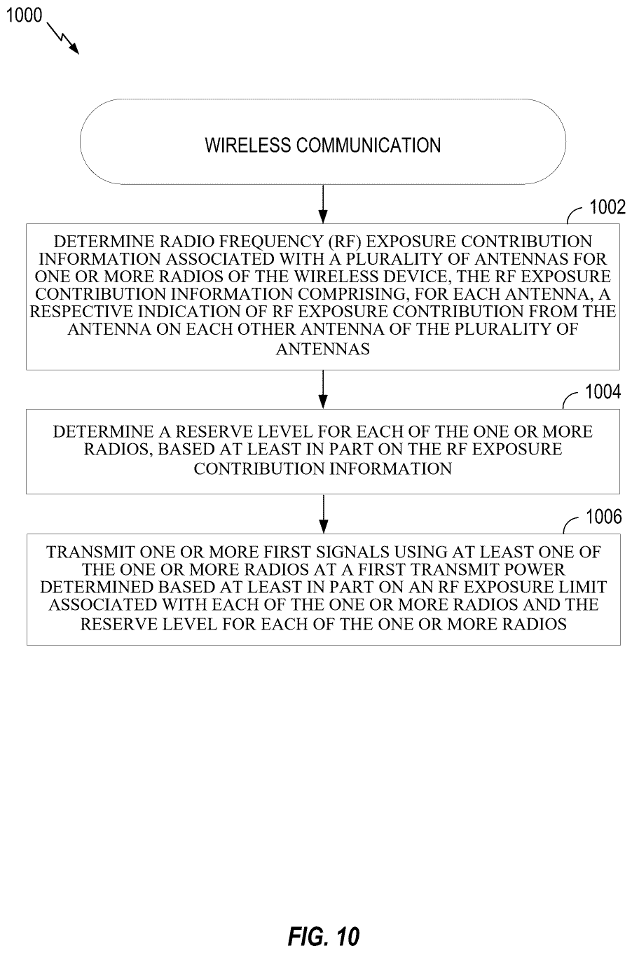

FIG. 10 is a flow diagram illustrating example operations 1000 for wireless communication. The operations 1000 may be performed, for example, by a wireless device (e.g., the wireless device 102 in the wireless communication system 100) and/or a processing system. The operations 1000 may be implemented as software components that are executed and run on one or more processors (e.g., the processor 210 and/or the modem 212 of FIG. 2).

The operations 1000 may involve, at block 1002, determining radio frequency (RF) exposure contribution information associated with a plurality of antennas for one or more radios of the wireless device, the RF exposure contribution information comprising, for each antenna, a respective indication of RF exposure contribution from the antenna on one or more RF exposure contributors. In certain aspects, the RF exposure contributors are representative of antennas of the wireless device. In certain aspects, the RF exposure contributors are representative of composite RF exposure maps for antennas of the wireless device. In certain aspects, the RF exposure contributors are representative of regions of an RF exposure map. In certain aspects, the RF exposure contributors are representative of surfaces of the wireless device.

The operations 1000 may also involve, at block 1004, determining a reserve level for each of the one or more radios, based at least in part on the RF exposure contribution information.

The operations 1000 may also involve, at block 1006, transmitting one or more first signals using at least one of the one or more radios at a first transmit power determined based at least in part on an RF exposure limit associated with each of the one or more radios and the reserve level for each of the one or more radios.

In certain aspects, the RF exposure contribution information may include, for each antenna, a contribution matrix including a respective contribution factor representative of a highest level of interaction of an RF exposure distribution for the antenna with one of the one or more RF exposure contributors. In such aspects, determining the RF exposure contribution information may include accessing stored indications of the contribution matrices.

In certain aspects, the RF exposure limit is a time-averaged RF exposure limit. In such aspects, determining the reserve level for each of the one or more radios may include distributing, from a total reserve available for the one or more radios during a time window associated with the time-averaged RF exposure limit, the reserve level for each radio based on the contribution factor for each antenna associated with the radio.

In certain aspects, the reserve level for each of the one or more radios may be equal to the total reserve.

In certain aspects, a portion of the total reserve allocated to the reserve level for each of the one or more radios may be in proportion to the respective contribution factors for the radio.

In certain aspects, the operations 1000 may further involve: (i) determining an allowed reserve margin for each of the one or more radios based at least in part on the reserve levels; and (ii) determining an excess reserve margin among the one or more radios with the allowed reserve margin greater than or equal to a first threshold, wherein determining the reserve level for each of the one or more radios further comprises distributing the excess reserve margin among the one or more radios with the allowed reserve margin less than or equal to a second threshold. In such aspects, the distribution of the excess reserve margin among the one or more radios with the allowed reserve margin less than or equal to the second threshold may be based on a respective priority of the one or more radios with the allowed reserve margin less than or equal to the second threshold.

In certain aspects, the operations 1000 may further involve: (i) determining an allowed exposure margin for each of the one or more radios during the time window based at least in part on the RF exposure contribution information; (ii) determining an excess margin among the one or more radios, based on the allowed exposure margins; and (iii) distributing the excess margin among the one or more radios based at least in part on the RF exposure contribution information.

In such aspects, distributing the excess margin may include distributing a portion of the excess margin to each radio based on the contribution factor for each antenna associated with the radio. The portion of the excess margin distributed to each radio may be in proportion to the respective contribution factors for the radio.

In certain aspects, the operations 1000 may further involve transmitting one or more second signals using at least one of the one or more radios at a second transmit power determined based at least in part on the excess margin for each of the one or more radios. The second transmit power may be greater than the reserve level for the at least one of the one or more radios.

In certain aspects, the operations 1000 may further involve: (i) determining that at least one of the contribution factors satisfies a predetermined condition; and (ii) in response to the determination, updating a value of the at least one of the contribution factors. The predetermined condition may include the least one of the contribution factors being below a threshold. In such aspects, updating the value of the at least one of the contribution factors may include adding a predetermined amount of RF exposure to the at least one of the contribution factors.

### Example Communications Device

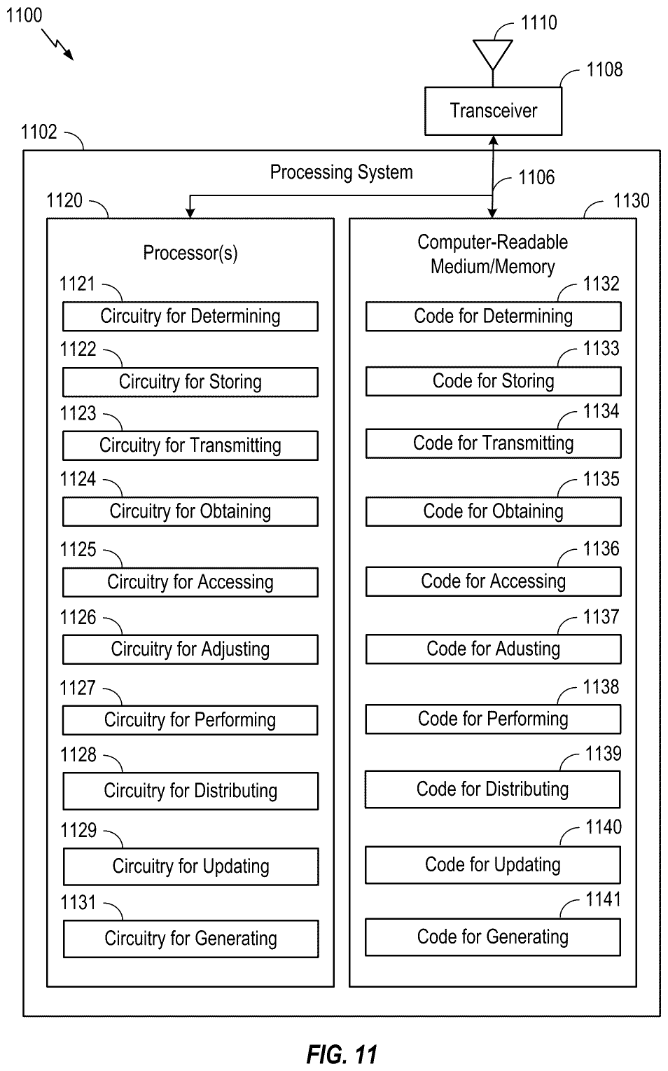

FIG. 11 depicts aspects of an example communications device 1100. In some aspects, communications device 1100 is a wireless communication device, such as the wireless device 102 described above with respect to FIGS. 1 and 2.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of any of the processor 210 and/or the modem 212, as described with respect to FIG. 2. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the operations 900 described with respect to FIG. 9, the operations 1000 described with respect to FIG. 10, or any aspect related to the operations described herein. Note that reference to a processor performing a function of communications device 1100 may include one or more processors performing that function of communications device 1100.

In the depicted example, computer-readable medium/memory 1130 stores code (e.g., executable instructions) for determining 1132, code for storing 1133, code for transmitting 1134, code for obtaining 1135, code for accessing 1136, code for adjusting 1137, code for performing 1138, code for distributing (including allocating) 1139, code for updating 1140, and code for generating (including regenerating) 1141. Processing of the code 1132-1141 may cause the communications device 1100 to perform the operations 900 described with respect to FIG. 9, the operations 1000 described with respect to FIG. 10, or any aspect related to operations described herein.

The one or more processors 1120 include circuitry configured to implement (e.g., execute) the code stored in the computer-readable medium/memory 1130, including circuitry for determining (including selecting) 1121, circuitry for storing 1122, circuitry for transmitting 1123, circuitry for obtaining 1124, circuitry for accessing 1125, circuitry for adjusting 1126, circuitry for performing 1127, circuitry for distributing (including allocating) 1128, circuitry for updating 1129, and circuitry for generating (including regenerating) 1131. Processing with circuitry 1121-1131 may cause the communications device 1100 to perform the operations 900 described with respect to FIG. 9, the operations 1000 described with respect to FIG. 10, or any aspect related to operations described herein.

Various components of the communications device 1100 may provide means for performing the operations 900 described with respect to FIG. 9, the operations 1000 described with respect to FIG. 10, or any aspect related to operations described herein. For example, means for transmitting, sending, or outputting for transmission may include the TX path 214 and/or antenna(s) 218 of the wireless device 102 illustrated in FIG. 2 and/or transceiver 1108 and antenna 1110 of the communications device 1100 in FIG. 11. Means for receiving or obtaining may include the RX path 216 and/or antenna(s) 218 of the wireless device 102 illustrated in FIG. 2, and/or transceiver 1108 and antenna 1110 of the communications device 1100 in FIG. 11. Means for controlling, means for performing, means for operating, means for distributing, means for updating, means for allocating, means for accessing, means for refraining, means for determining, means for detecting, means for storing, means for accessing, means for adjusting, means for (re) generating, means for using, means for obtaining, and/or means for providing may include a processor, such as the processor 210 and/or modem 212 depicted in FIG. 2 and/or the processor(s) 1120 in FIG. 11.

### Example Aspects

Implementation examples are described in the following numbered clauses:

Aspect 1: A method of wireless communication by a wireless device, comprising: determining radio frequency (RF) exposure contribution information associated with a plurality of antennas for one or more radios of the wireless device, the RF exposure contribution information comprising, for each antenna, a respective indication of RF exposure contribution from the antenna on one or more RF exposure contributors; determining a reserve level for each of the one or more radios, based at least in part on the RF exposure contribution information; and transmitting one or more first signals using at least one of the one or more radios at a first transmit power determined based at least in part on an RF exposure limit associated with each of the one or more radios and the reserve level for each of the one or more radios.

Aspect 2: The method of Aspect 1, wherein the RF exposure contribution information comprises, for each antenna, a contribution matrix comprising a respective contribution factor representative of a highest level of interaction of an RF exposure distribution for the antenna with an RF exposure distribution for one of the one or more RF exposure contributors.

Aspect 3: The method of any of Aspects 1-2, wherein the one or more RF exposure contributors comprise each other antenna of the plurality of antennas.

Aspect 4: The method of any of Aspects 1-2, wherein the one or more RF exposure contributors comprise one or more regions of the RF exposure distribution for the one or more RF exposure contributors.

Aspect 5: The method of any of Aspects 1-2, wherein the one or more RF exposure contributors comprise one or more surfaces of the wireless device.

Aspect 6: The method of any of Aspects 2-5, wherein determining the RF exposure contribution information comprises accessing stored indications of the contribution matrices.

Aspect 7: The method of any of Aspects 2-6, wherein: the RF exposure limit is a time-averaged RF exposure limit; and determining the reserve level for each of the one or more radios comprises distributing, from a total reserve available for the one or more radios during a time window associated with the time-averaged RF exposure limit, the reserve level for each radio based on the contribution factor for each antenna associated with the radio.

Aspect 8: The method of Aspect 7, wherein the reserve level for each of the one or more radios is equal to the total reserve.

Aspect 9: The method of Aspect 7, wherein a portion of the total reserve allocated to the reserve level for each of the one or more radios is in proportion to the respective contribution factors for the radio.

Aspect 10: The method of any of Aspects 7-9, further comprising: determining an allowed reserve margin for each of the one or more radios based at least in part on the reserve levels; and determining an excess reserve margin among the one or more radios with the allowed reserve margin greater than or equal to a first threshold, wherein determining the reserve level for each of the one or more radios further comprises distributing the excess reserve margin among the one or more radios with the allowed reserve margin less than or equal to a second threshold.

Aspect 11: The method of Aspect 10, wherein the distribution of the excess reserve margin among the one or more radios with the allowed reserve margin less than or equal to the second threshold is based on a respective priority of the one or more radios with the allowed reserve margin less than or equal to the second threshold.

Aspect 12: The method of any of Aspects 7-11, further comprising: determining an allowed exposure margin for each of the one or more radios during the time window based at least in part on the RF exposure contribution information; determining an excess margin among the one or more radios, based on the allowed exposure margins; and distributing the excess margin among the one or more radios based at least in part on the RF exposure contribution information.

Aspect 13: The method of Aspect 12, wherein distributing the excess margin comprises distributing a portion of the excess margin to each radio based on the contribution factor for each antenna associated with the radio.

Aspect 14: The method of Aspect 13, wherein the portion of the excess margin distributed to each radio is in proportion to the respective contribution factors for the radio.

Aspect 15: The method of any of Aspects 12-14, further comprising transmitting one or more second signals using at least one of the one or more radios at a second transmit power determined based at least in part on the excess margin for each of the one or more radios.

Aspect 16: The method of Aspect 15, wherein the second transmit power is greater than the reserve level for the at least one of the one or more radios.

Aspect 17: The method of any of Aspects 2-16, further comprising: determining that at least one of the contribution factors satisfies a predetermined condition; and in response to the determination, updating a value of the at least one of the contribution factors.

Aspect 18: The method of Aspect 17, wherein: the predetermined condition comprises the least one of the contribution factors being below a threshold; and updating the value of the at least one of the contribution factors comprises adding a predetermined amount of RF exposure to the at least one of the contribution factors.

Aspect 19: An apparatus, comprising: one or more memories collectively storing executable instructions; and one or more processors coupled to the one or more memories, the one or more processors being collectively configured to execute the executable instructions to cause the apparatus to perform a method in accordance with any of Aspects 1-18.

Aspect 20: An apparatus, comprising means for performing a method in accordance with any of Aspects 1-18.

Aspect 21: A non-transitory computer-readable medium comprising computer-executable instructions that, when executed by one or more processors of a processing system, cause the processing system to perform a method in accordance with any of Aspects 1-18.

Aspect 22: A computer program product embodied on a computer-readable storage medium comprising code for performing a method in accordance with any of Aspects 1-18.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 9 and 10).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
determining radio frequency (RF) exposure contribution information associated with a plurality of antennas for one or more radios of the wireless device, the RF exposure contribution information comprising, for each antenna, a respective indication of RF exposure contribution from the antenna on one or more RF exposure contributors;
determining a reserve level for each of the one or more radios, based at least in part on the RF exposure contribution information; and
transmitting one or more first signals using at least one of the one or more radios at a first transmit power determined based at least in part on an RF exposure limit associated with each of the one or more radios and the reserve level for each of the one or more radios.

2. The method of claim 1, wherein the RF exposure contribution information comprises, for each antenna, a contribution matrix comprising a respective contribution factor representative of a highest level of interaction of an RF exposure distribution for the antenna with an RF exposure distribution for one of the one or more RF exposure contributors.

3. The method of claim 2, wherein the one or more RF exposure contributors comprise each other antenna of the plurality of antennas.

4. The method of claim 2, wherein the one or more RF exposure contributors comprise one or more regions of the RF exposure distribution for the one or more RF exposure contributors.

5. The method of claim 2, wherein the one or more RF exposure contributors comprise one or more surfaces of the wireless device.

6. The method of claim 2, wherein determining the RF exposure contribution information comprises accessing stored indications of the contribution matrices.

7. The method of claim 2, wherein:
the RF exposure limit is a time-averaged RF exposure limit; and
determining the reserve level for each of the one or more radios comprises distributing, from a total reserve available for the one or more radios during a time window associated with the time-averaged RF exposure limit, the reserve level for each radio based on the contribution factor for each antenna associated with the radio.

8. The method of claim 7, wherein the reserve level for each of the one or more radios is equal to the total reserve.

9. The method of claim 7, wherein a portion of the total reserve allocated to the reserve level for each of the one or more radios is in proportion to the respective contribution factors for the radio.

10. The method of claim 7, further comprising:
determining an allowed reserve margin for each of the one or more radios based at least in part on the reserve levels; and
determining an excess reserve margin among the one or more radios with the allowed reserve margin greater than or equal to a first threshold, wherein determining the reserve level for each of the one or more radios further comprises distributing the excess reserve margin among the one or more radios with the allowed reserve margin less than or equal to a second threshold.

11. The method of claim 10, wherein the distribution of the excess reserve margin among the one or more radios with the allowed reserve margin less than or equal to the second threshold is based on a respective priority of the one or more radios with the allowed reserve margin less than or equal to the second threshold.

12. The method of claim 7, further comprising:
determining an allowed exposure margin for each of the one or more radios during the time window based at least in part on the RF exposure contribution information;
determining an excess margin among the one or more radios, based on the allowed exposure margins; and
distributing the excess margin among the one or more radios based at least in part on the RF exposure contribution information.

13. The method of claim 12, wherein distributing the excess margin comprises distributing a portion of the excess margin to each radio based on the contribution factor for each antenna associated with the radio.

14. The method of claim 13, wherein the portion of the excess margin distributed to each radio is in proportion to the respective contribution factors for the radio.

15. The method of claim 12, further comprising transmitting one or more second signals using at least one of the one or more radios at a second transmit power determined based at least in part on the excess margin for each of the one or more radios.

16. The method of claim 15, wherein the second transmit power is greater than the reserve level for the at least one of the one or more radios.

17. The method of claim 2, further comprising:
determining that at least one of the contribution factors satisfies a predetermined condition; and
in response to the determination, updating a value of the at least one of the contribution factors.

18. The method of claim 17, wherein:
the predetermined condition comprises the least one of the contribution factors being below a threshold; and
updating the value of the at least one of the contribution factors comprises adding a predetermined amount of RF exposure to the at least one of the contribution factors.

19. An apparatus for wireless communication, comprising:
one or more memories collectively storing executable instructions; and
one or more processors coupled to the one or more memories, the one or more processors being collectively configured to execute the executable instructions to cause the apparatus to:
determine radio frequency (RF) exposure contribution information associated with a plurality of antennas for one or more radios of the apparatus, the RF exposure contribution information comprising, for each antenna, a respective indication of RF exposure contribution from the antenna on one or more RF exposure contributors;
determine a reserve level for each of the one or more radios, based at least in part on the RF exposure contribution information; and
transmit one or more first signals using at least one of the one or more radios at a first transmit power determined based at least in part on an RF exposure limit associated with each of the one or more radios and the reserve level for each of the one or more radios.

20. An apparatus for wireless communication, comprising:
means for determining radio frequency (RF) exposure contribution information associated with a plurality of antennas for one or more radios of the apparatus, the RF exposure contribution information comprising, for each antenna, a respective indication of RF exposure contribution from the antenna on one or more RF exposure contributors;
means for determining a reserve level for each of the one or more radios, based at least in part on the RF exposure contribution information; and
means for transmitting one or more first signals using at least one of the one or more radios at a first transmit power determined based at least in part on an RF exposure limit associated with each of the one or more radios and the reserve level for each of the one or more radios.
